(19) United States
(12) Patent Application Publication
(10) Pub. No.: US 2007/0024228 A1
(43) Pub. Date: Feb. 1, 2007

(54) STEPPING MOTOR DRIVE APPARATUS AND CONTROL METHOD THEREOF

(75) Inventor: Hiroshi FUJINAKA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/460,384

(22) Filed: Jul. 27, 2006

(30) Foreign Application Priority Data
Jul. 28, 2005 (JP) 2005/218352

(51) Int. Cl. H02P 8/00

(52) U.S. Cl. 318/696

(57) ABSTRACT

To provide a stepping motor drive apparatus for driving a stepping motor, that is a driving object, with low noise and low vibration. The stepping motor drive apparatus is composed of: a reference signal generation unit for generating a reference signal that shows a limit value of a current to be supplied to a coil; a switching unit for supplying the current to the coil in an ON state and stopping the current supply to the coil in an OFF state; a coil current measurement unit for measuring the current supplied to the coil; a standard pulse generation unit for outputting a standard pulse at a fixed time interval; a timer unit for outputting a completion signal showing that a predetermined period of time shorter than the fixed time interval has elapsed since the standard pulse was outputted; and a pulse-width modulation control unit for setting the switching unit to the ON state at a point in time when the standard pulse is outputted, and setting the switching unit to the OFF state either at a point in time when the current measured by the coil current measurement unit exceeds the current limit value shown by the reference signal or at a point in time when the completion signal is outputted from the timer unit, whichever occurs first.

### BACKGROUND OF THE INVENTION

(1) Field of the Invention

The present invention relates to a stepping motor drive apparatus, and more particularly to a technique of driving a stepping motor with low noise and low vibration.

(2) Description of the Related Art

For various kinds of position controls, stepping motors have been conventionally used. A stepping motor is composed of a rotor and a stator that has coils of plural phases, the rotor rotating a specific number of degrees in rotation. With control over the number of rotation steps, the rotor rotates only by an intended angle without feedback control. This performance characteristic of such a stepping motor is suitable for use in position control.

In recent years, stepping motors have been used as optical actuators in photographic electronic apparatuses, such as a DSC (Digital Still Camera, or so-called “digital camera”) and a DVC (Digital Video Camera), for adjusting aperture, focus, zoom, and so forth.

Stepping motors, especially those used in photographic electronic apparatuses, are required to operate with low noise and low vibration. This is because sound generated by a stepping motor is caught by a built-in microphone of a photographic electronic apparatus and recorded as noise, and vibration generated by the stepping motor causes unsteadiness of the apparatus and thus results in degradation in picture quality. In response to the requirement, a technique of driving a stepping motor with low noise and low vibration is disclosed, for instance, in Japanese Patent Application Publication No. 2004-215385.

FIG. 1 is a diagram showing a construction of a conventional stepping motor drive apparatus disclosed in the above Publication. In regard to this conventional apparatus, the following description focuses only on components that are necessary for explaining the principle of the apparatus. The stepping motor of this apparatus has coils of plural phases, and the same set of components is provided for each coil. For this reason, the explanation below is given only as to a coil of one phase and to components provided for that coil.

As shown in FIG. 1, the conventional stepping motor drive apparatus is composed of: a power source 1; a stepping motor 2 that is a controlled object having a coil 3 and a rotator 4; a switching unit 5 for controlling a current to be supplied to the coil 3; a reference signal generator 14 for generating a reference signal showing a current limit value; a PWM control unit 15; and a coil current measurement unit 20. The switching unit 5 has transistors 6 to 9 and flywheel diodes 10 to 13, which form current supply paths to the coil 3. The PWM control unit 15 has a comparator 16, a flip-flop 17, a pulse generator 18, and an energization logic unit 19. As already mentioned above, each coil has the same set of components and, therefore, the other coils provided for the stepping motor 2 and the components of these coils will not be illustrated or explained. The following is a description of the components provided for the coil 3.

The pulse generator 18 outputs a standard pulse signal to set the flip-flop 17 at a fixed time interval. This allows the energization logic unit 19 to bring the transistor 6 or 9 into conduction with the transistor 7 or 8 at the fixed time interval on the basis of a combination of the transistors as well as timing whereby a through current does not flow. The coil current measurement unit 20 detects the current that is supplied from the power source 1 to the coil 3 by means of the conduction of the transistors 6 to 9, and then outputs the detected current as a detected current value to the comparator 16. Note that the current detected by the coil current measurement unit 20, that is, the current passing through the coil 3, is simply referred to as the “detected current value” hereafter in the following description about the operations performed by the apparatus.

The reference signal generator 14 generates a “staircase” waveform that rises and falls with a stepwise motion, and then outputs the waveform as a reference signal showing a current limit value. This reference signal showing the current limit value will be used as a signal showing a current target value for the current passing through the coil 3. Hereafter, the current passing through the coil 3 is referred to as the “coil current” and the reference signal generated by the reference signal generator 14 is simply referred to as a “current target value”.

The comparator 16 compares the detected current value with the current target value, and resets the flip-flop 17 at the point in time when the detected current value exceeds the current target value. Upon the reset of the flip-flop 17, the energization logic unit 19 drives both the transistors 7 and 8 included in the switching unit 5 into cutoff.

In the case where the transistors 6 and 9 are also cut off while the transistors 7 and 8 are being cut off, the coil current circulates between the flywheel diode 11 or 12 and the flywheel diode 10 or 13. When both the transistors 6 and 9 are brought into conduction while the transistors 7 and 8 are being cut off, the coil current circulates between the transistors 6 and 9. When only one of the transistors 6 and 9 is brought into conduction while the transistors 7 and 8 are being cut off, the coil current circulates between the flywheel diode 11 or 12 and the transistor 6 or 9 if the flywheel diode connected to the transistor that is not conducting is biased in the forward direction. When the flywheel diode connected to the transistor that is not conducting is biased in the reverse direction, the coil current circulates between the flywheel diode 10 or 13 and the transistor 6 or 9.

After the reset of the flip-flop 17, the pulse generator 18 sets the flip-flop 17 at the fixed time interval. Accordingly, the above operation will be repeated.

In this way, the current to be supplied to the coil 3 is so controlled that the mean value of the current is asymptotic to the current target value. As the current target value rises and falls with the stepwise motion, the mean current to be supplied to the coil 3 also rises and falls with the stepwise motion. As to the other coils of different phases, the stepping motor 2 also rotates at a rotation speed corresponding to a speed at which the steps rise and fall.

Unfortunately, such a conventional stepping motor drive apparatus has the following two problems. The first problem is that a frequency of the current waveform becomes lower than the frequency of pulse-width modulation. Hereafter, the frequency of pulse-width modulation is referred to as the “PWM frequency”. The second problem is that the ripple of the coil current is large. These two problems are explained below, with reference to FIG. 2.

FIG. 2 is a diagram showing waveforms generated by the conventional stepping motor drive apparatus. As shown in FIG. 2 (a), the pulse generator 18 outputs a standard pulse signal for setting the flip-flop 17 for each pulse-width modulation cycle. This pulse-width modulation cycle is referred as the “PWM cycle” hereafter. By this signal from the pulse generator 18, the flip-flop 17 is accordingly set as shown in FIG. 2 (c). While the flip-flop 17 is being set, electric power is supplied from the power source 1 to the coil 3, thereby increasing the coil current as shown in FIG. 2 (e). Note that a time period starting from the set of the flip-flop 17 during which the coil current is increasing with the power supply is referred to as the “PWM ON period”.

As a result of the increase in the coil current during the PWM ON period, the detected current value shown in FIG. 2 (g) exceeds the current target value shown in FIG. 2 (f). At the point in time when the detected current value exceeds the current target value, the comparator 16 outputs a signal for resetting the flip-flop 17 as shown in FIG. 2 (b). By this signal, the flip-flop 17 is reset as shown in FIG. 2 (c). Note, however, that after the flip-flop 17 is set, the detected current value does not necessarily exceed the current target value within a duration indicated as a PWM cycle T shown in FIG. 2. In other words, the PWM ON period may continue for a plurality of PWM cycles until the detected current value exceeds the current target value. In this case, a frequency of the coil current becomes lower than the PWM frequency. Suppose here that the PWM frequency is 100 KHz and set to exceed the audio-frequency region so as not to be considered as noise. Even in this case, when the PWM ON period continues for a plurality of PWM cycles and the substantial PWM frequency decreases, such as when the PWM ON period continues for 5 or more cycles and the frequency drops to 20 KHz or less, the PWM frequency is within the audio-frequency region and is considered as noise.

On the other hand, during the reset of the flip-flop 17, the power supply from the power source 1 to the coil 3 is cut off and the coil current decreases as shown in FIG. 2 (e) due to the flow circulation. Note that a time period during which the coil current is decreasing with the flow circulation after the reset of the flip-flop 17 is referred to as the “PWM OFF period”. Also, note that the state of the coil current within the cycle, that is determined as the PWM ON period or the PWM OFF period, is referred to as the “coil current state” hereafter. When an inductance value of the coil 3 is represented as “L” and a voltage applied to the coil 3 during the PWM OFF period as “Voff”, the slope of the decreasing current is given by the expression Voff/L. As explained, the coil current decreases during the PWM OFF period. Then, when the pulse generator 18 outputs a signal again to set the flip-flop 17, the coil current state is caused to transition to the PWM ON period. As a result, the coil current starts increasing again as shown in FIG. 2 (e).

Here, in the case where the detected current value exceeds the current target value immediately after the pulse generator 18 outputs the signal for setting the flip-flop 17, a period of time taken from the signal output by the pulse generator 18 to the transition to the PWM OFF period is extremely short. This means that the PWM OFF period will continue for a period of time corresponding to the remaining time of the PWM cycle T. That is, the length of the present PWM OFF period will become almost equal to the length of the PWM cycle T. Such a phenomenon like this occurs when the coil current state transitions to the PWM ON period in a situation where the immediately preceding PWM OFF period is extremely short and the amount of coil current decreased with respect to the current target value during that PWM OFF period is extremely small. Or, this phenomenon occurs when a timing at which the detected current value exceeds the current target value coincides with a timing at which the pulse generator 18 outputs a signal for setting the flip-flop 17.

An explanation is given as to the amount of coil current decreased during a PWM OFF period. The amount of decrease in the coil current reaches the maximum under a condition where the length of the PWM OFF period is equivalent to the length of the PWM cycle T. The maximum amount of decrease is expressed as (Voff/L)·T, and this amount is extremely large. An ideal stepping motor drive apparatus so operates as to reliably cause the transition to the PWM OFF period to take place following the end of the PWM ON period within the PWM cycle T. That is to say, the ideal stepping motor drive apparatus operates so as to supply the current to the coil 3 according to a fixed duty. Here, the duty refers to a ratio of the PWM ON period to the PWM cycle T, and the ratio is given by the expression [PWM ON period/PWM cycle T]. In the case of the ideal stepping motor drive apparatus, the time length of a PWM OFF period is set shorter than the PWM cycle T, such as 20% of the PWM cycle T. When the time length of the PWM OFF period is represented as “Toff”, the amount of decrease in the coil current during the time length Toff is expressed as (Voff/L-Toff). As can be understood, the amount of decrease here is also small, such as 20% of the amount of the decrease in the case of the conventional stepping motor drive apparatus. For this reason, the current ripple caused by the conventional stepping motor drive apparatus can be considered to be much larger than the current ripple caused by the ideal stepping motor drive apparatus. This increase in the current ripple causes vibration to the stepping motor.

Due to the decrease in frequency of the current waveform and the increase in current ripple, the conventional stepping motor drive apparatus cannot adequately achieve the effect of reducing noise and vibration caused by the stepping motor, especially when used in a video-recording electronic apparatus. Thus, there is still a need for a stepping motor operating with lower noise and lower vibration.

### SUMMARY OF THE INVENTION

The present invention was conceived in view of the stated problems, and has an object of providing a stepping motor drive apparatus and a control method thereof for reducing noise and vibration caused by a stepping motor that is a driving object. In order to achieve the stated object, a first stepping motor drive apparatus of the present invention is composed of: a reference signal generation unit operable to generate a reference signal that shows a current limit value of a current to be supplied to a coil included in the stepping motor; a switching unit operable to supply the current to the coil in an ON state, and to stop the current supply to the coil in an OFF state; a coil current measurement unit operable to measure the current supplied to the coil; a standard pulse generation unit operable to output a standard pulse at a fixed time interval; a timer unit operable to output a completion signal which indicates that a predetermined period of time shorter than the fixed time interval has elapsed since the standard pulse was outputted; and a control unit operable to set the switching unit to the ON state at a point in time when the standard pulse is outputted, and to set the switching unit to the OFF state either at a point in time when the current measured by the coil current measurement unit exceeds the current limit value shown by the reference signal or at a point in time when the completion signal is outputted from the timer unit, whichever occurs first. With this construction, the coil current state is caused to transition to the PWM OFF period either at the point in time when the coil current exceeds the current limit value or at the point in time when the predetermined period of time shorter than the PWM cycle has elapsed, whichever occurs first. On account of this, the coil current increases and then decreases within the period of time shorter than the PWM cycle. This prevents a decrease in the frequency of the current waveform as well as preventing an increase in the current ripple, thereby realizing a stepping motor that operates with low noise and low vibration.

Here, the control unit may have, for example: a comparator operable to detect that the current has exceeded the current limit value by comparing a signal which shows an amount of the current measured by the coil current measurement unit with the reference signal; an OR gate operable to perform an OR operation on an output signal from the comparator and the completion signal from the timer unit; a flip-flop which is set by the standard pulse and reset by an output signal from the OR gate; and an energization logic unit operable to set the switching unit to the ON state when an output signal from the flip-flop is in a first state, and to set the switching unit to the OFF state when the output signal from the flip-flop is in a second state.

Moreover, a second stepping motor drive apparatus of the present invention is composed of: a maximum value indication unit operable to indicate a maximum value of the current limit value; and a memory unit operable to hold a table which stores a plurality of combinations each including the maximum value and a timer setting value representing a period of time for which the timer unit is set, to read the timer setting value from the table corresponding to the maximum value indicated by the maximum value indication unit, and then to output the read timer setting value to the timer unit, wherein the timer unit is operable to measure the predetermined period of time by reference to the timer setting value outputted from the memory unit, and to output the completion signal on completion of measuring the predetermined period of time, and the reference signal generation unit is operable to generate the reference signal that causes a maximum value of the current limit value shown by the reference signal to be the maximum value indicated by the maximum value indication unit. With this, the timer setting value can be varied depending on the amount of the target current. This allows the pulse-width modulation control to be precisely optimized in accordance with the amount of the target current, thereby realizing a stepping motor that operates with low noise and low vibration.

Furthermore, a third stepping motor drive apparatus of the present invention is composed of: a time length indication unit operable to indicate to the timer unit a timer setting value representing a period of time, for which the timer unit is set, wherein the timer unit is operable to measure the predetermined period of time by reference to the timer setting value indicated by the time length indication unit, and to output the completion signal on completion of measuring the predetermined period of time. With this, the timer setting value can be varied following an instruction that is externally given. This allows the pulse-width modulation control to be precisely optimized in accordance with the amount of the target current, thereby realizing a stepping motor that operates with low noise and low vibration.

Moreover, a fourth stepping motor drive apparatus of the present invention is composed of: a step control unit operable to output a step signal at a fixed time interval, the step signal showing a time position in one cycle of the reference signal; and a memory unit operable to hold a table which stores a plurality of combinations each including the time position shown by the step signal and a timer setting value representing a period of time for which the timer unit is set, to read, when receiving the step signal from the step control unit, the timer setting value from the table corresponding to the time position shown by the received step signal, and then to output the read timer setting value to the timer unit, wherein the timer unit is operable to measure the predetermined period of time by reference to the timer setting value outputted from the memory unit, and to output the completion signal on completion of measuring the predetermined period of time, and the reference signal generation unit is operable, when receiving the step signal from the step control unit, to generate the reference signal that shows the current limit value corresponding to the time position shown by the received step signal. With this, the timer setting value can be varied depending on the time position in one cycle of the current limit value. This allows the pulse-width modulation control to be precisely optimized in accordance with the phase of the target current, thereby realizing a stepping motor that operates with low noise and low vibration.

Furthermore, a fifth stepping motor drive apparatus of the present invention is composed of: a maximum value indication unit operable to indicate a maximum value of the current limit value; a step control unit operable to output a step signal at a fixed time interval, the step signal showing a time position in one cycle of the reference signal; and a memory unit operable to hold a table which stores a plurality of combinations each including a timer setting value representing a period of time for which the timer unit is set and a pair of the maximum value and the time position shown by the step signal, to read, when receiving the step signal from the step control unit, the timer setting value from the table corresponding to the combination of the maximum value indicated by the maximum value indication unit and the time position shown by the step signal outputted from the step control unit, and then to output the read timer setting value to the timer unit, wherein the timer unit is operable to measure the predetermined period of time by reference to the timer setting value outputted from the memory unit, and to output the completion signal on completion of measuring the predetermined period of time, and the reference signal generation unit is operable, when receiving the step signal from the step control unit, to generate the reference signal that shows the current limit value corresponding to the combination of the maximum value indicated by the maximum value indication unit and the time position shown by the step signal outputted from the step control unit. With this, the timer setting value can be varied depending on the amount of target current and on the time position in one cycle of the current limit value. This allows the pulse-width modulation control to be precisely optimized in accordance with the amount and phase of the target current, thereby realizing a stepping motor that operates with low noise and low vibration.

Moreover, a sixth stepping motor drive apparatus of the present invention is composed of: a step control unit operable to output a step signal at a fixed time interval, the step signal showing a time position in one cycle of the reference signal; a time length indication unit operable to indicate a plurality of combinations each including the time position shown by the step signal and a timer setting value representing a period of time for which the timer unit is set; and a memory unit operable to hold a table which stores the plurality of combinations indicated by the time length indication unit, to read, when receiving the step signal from the step control unit, the timer setting value from the table corresponding to the time position shown by the received step signal, and then to output the read timer setting value to the timer unit, wherein the timer unit is operable to measure the predetermined period of time by reference to the timer setting value outputted from the memory unit, and to output the completion signal on completion of measuring the predetermined period of time, and the reference signal generation unit is operable, when receiving the step signal from the step control unit, to generate the reference signal that shows the current limit value corresponding to the time position shown by the received step signal. With this, the timer setting value can be varied depending on the amount of the target current and on the time position in one cycle of the current limit value. This allows the pulse-width modulation control to be precisely optimized in accordance with the amount and phase of the target current, thereby realizing a stepping motor that operates with low noise and low vibration.

It should be noted here that the memory unit included in the stepping motor drive apparatus of the present invention may be replaced with a different unit that determines a timer setting value according to a predetermined calculation formula. To be more specific, the stepping motor drive apparatus may be further composed of: a timer setting value calculation unit operable to receive an indication regarding at least one of a maximum value of the current limit value and a time position in one cycle of the current limit value and to calculate a timer setting value representing a period of time for which the timer unit is set, from at least one of the indicated maximum value and the indicated time position, wherein the timer unit is operable to measure the predetermined period of time by reference to the timer setting value calculated by the timer setting value calculation unit, and to output the completion signal on completion of measuring the predetermined period of time. In this way, since an optimum timer setting value is dynamically calculated, a table storing various timer setting values does not need to be held.

Note that the present invention can be realized not only as a stepping motor drive apparatus described above, but also as: a semiconductor integrated circuit that realizes the same functions as those of the apparatus by a single chip circuit; a control method used by the stepping motor drive apparatus; a program causing a computer to execute steps included in the control method; and a computer-readable recording medium, such as a CD-ROM, that records the program.

According to the stepping motor drive apparatus of the present invention, the coil current state is caused to transition to the PWM OFF period using the timer unit that limits the length of the PWM ON period in addition to using the comparison result between the current value detected by the coil current measurement unit and the current limit value outputted from the reference signal generation unit. In this way, the maximum length of the PWM ON period is limited within the PWM cycle. This can prevent the PWM ON period from continuing for a plurality of PWM cycles, thereby also preventing a decrease in the frequency of the current waveform.

Moreover, the maximum PWM OFF period is given by subtracting the minimum PWM ON period from the PWM cycle, so as to be definitely shorter than the PWM cycle T. Accordingly, the current ripple can be reduced as compared with the case of the conventional stepping motor drive apparatus.

By preventing both a decrease in the frequency of the current waveform and an increase in the current ripple, the stepping motor drive apparatus can operate with low noise and low vibration.

Further Information about Technical Background to this Application

The disclosure of Japanese Patent Application No. 2005-218352 filed on Jul. 28, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing a construction of a conventional stepping motor driving apparatus;

FIG. 2 is a diagram showing waveforms generated by the conventional stepping motor driving apparatus;

FIG. 3 is a block diagram showing a construction of a stepping motor drive apparatus according to a first embodiment of the present invention;

FIG. 4 is a diagram showing waveforms generated by the stepping motor drive apparatus according to the first embodiment of the present invention;

FIGS. 5A and 5B are diagrams showing current paths of the stepping motor drive apparatus according to the first embodiment of the present invention;

FIG. 6 is a diagram showing an example of a coil current measurement unit according to the first embodiment of the present invention;

FIG. 7 is a diagram showing waveforms generated by an ideal stepping motor drive apparatus;

FIGS. 8A and 8B are diagrams showing other examples of the current path of the stepping motor drive apparatus according to the first embodiment of the present invention;

FIGS. 9A and 9B are diagrams showing other examples of the coil current measurement unit according to the first embodiment of the present invention;

FIG. 10 is a block diagram showing a construction of a stepping motor drive apparatus according to a second embodiment of the present invention;

FIG. 11 is a block diagram showing a detailed construction of a maximum value indication unit according to the second embodiment of the present invention;

FIG. 12 is a diagram showing an example of a table held by a memory unit according to the second embodiment of the present invention;

FIG. 13 is a block diagram showing a construction of a stepping motor drive apparatus according to a third embodiment of the present invention;

FIG. 14 is a block diagram showing a construction of a stepping motor drive apparatus according to a fourth embodiment of the present invention;

FIG. 15 is a block diagram showing respective detailed constructions of a step control unit and a reference signal generation unit according to the fourth embodiment of the present invention;

FIG. 16 is a diagram showing an example of current target value according to the fourth embodiment of the present invention;

FIG. 17 is a diagram showing an example of a table held by a memory unit according to the fourth embodiment of the present invention;

FIG. 18 is a block diagram showing a construction of a stepping motor drive apparatus according to a fifth embodiment of the present invention;

FIG. 19 is a block diagram showing respective detailed constructions of a step control unit, a reference signal generation unit, and a maximum value indication unit according to the fifth embodiment of the present invention;

FIG. 20 is a diagram showing an example of a table held by a memory unit according to the fifth embodiment of the present invention; and

FIG. 21 is a block diagram showing a construction of a stepping motor drive apparatus according to a sixth embodiment of the present invention.

### DESCRIPTION OF THE PREFERRED EMBODIMENTS

The following is a description of embodiments of a stepping motor drive apparatus of the present invention, with reference to the drawings.

### First Embodiment

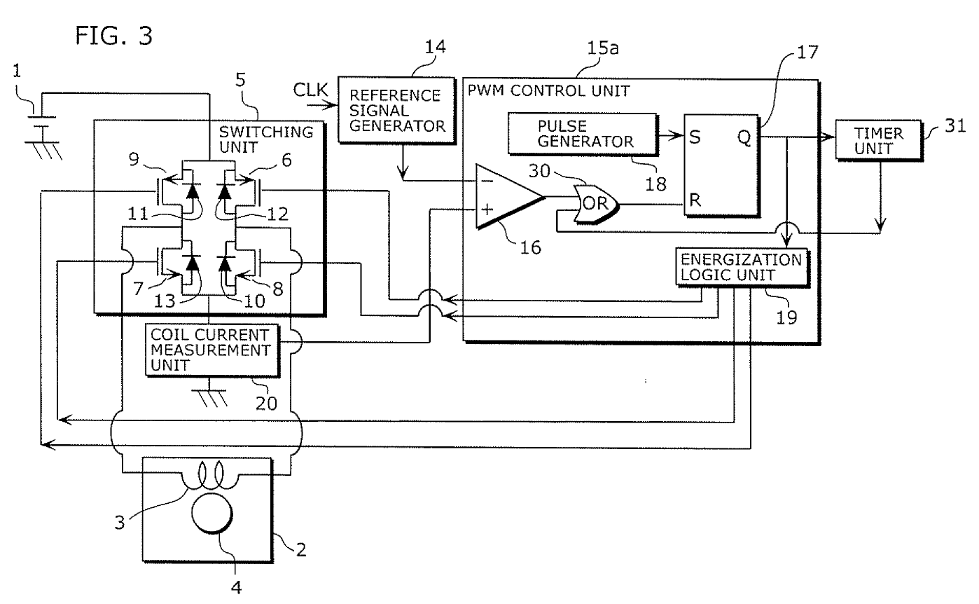

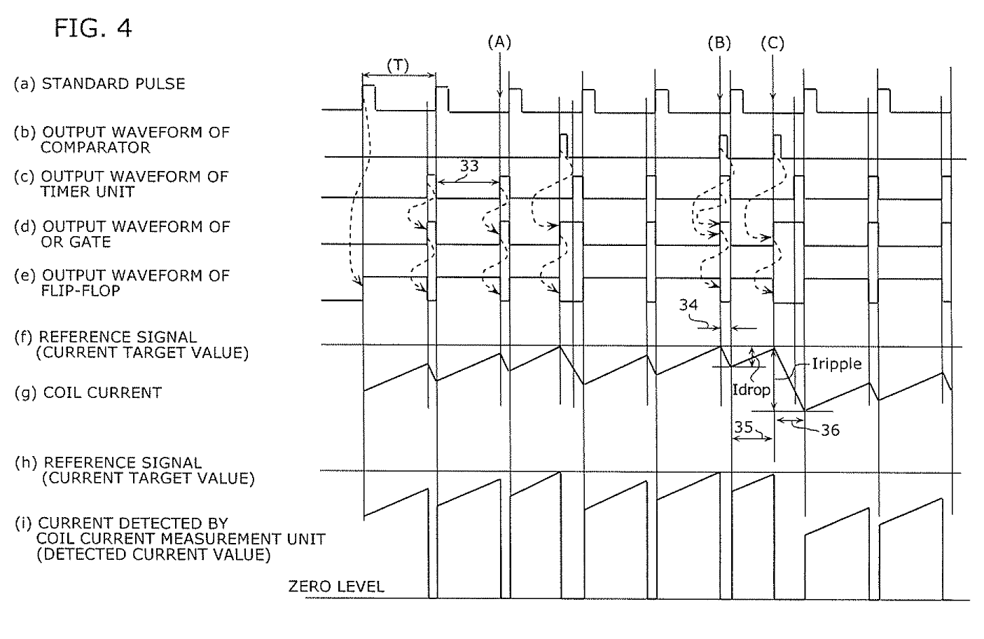

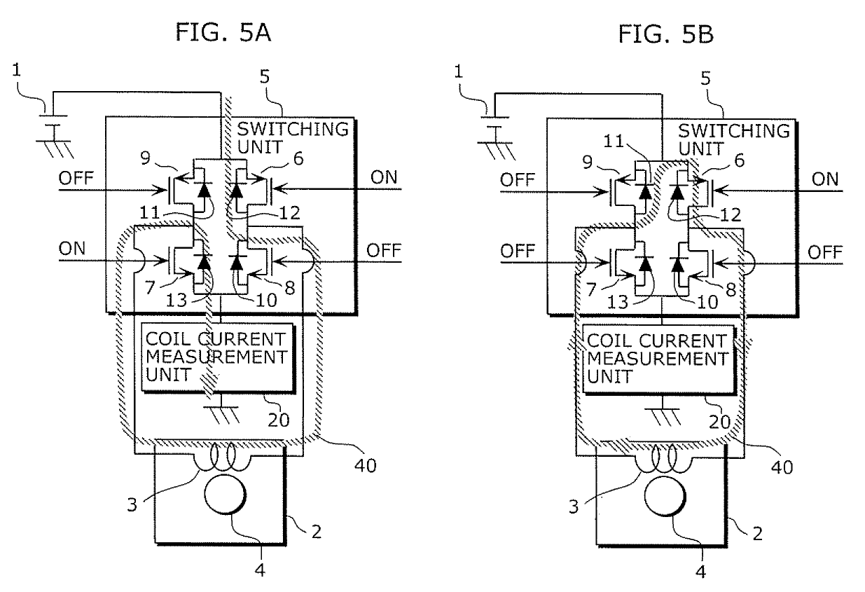

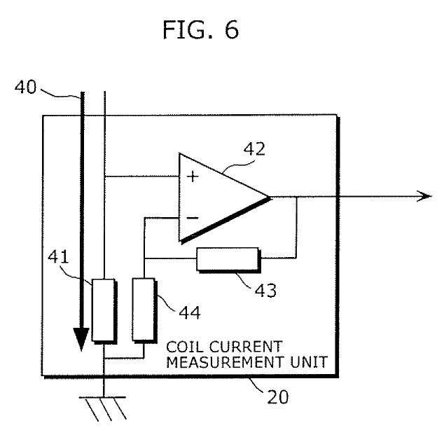

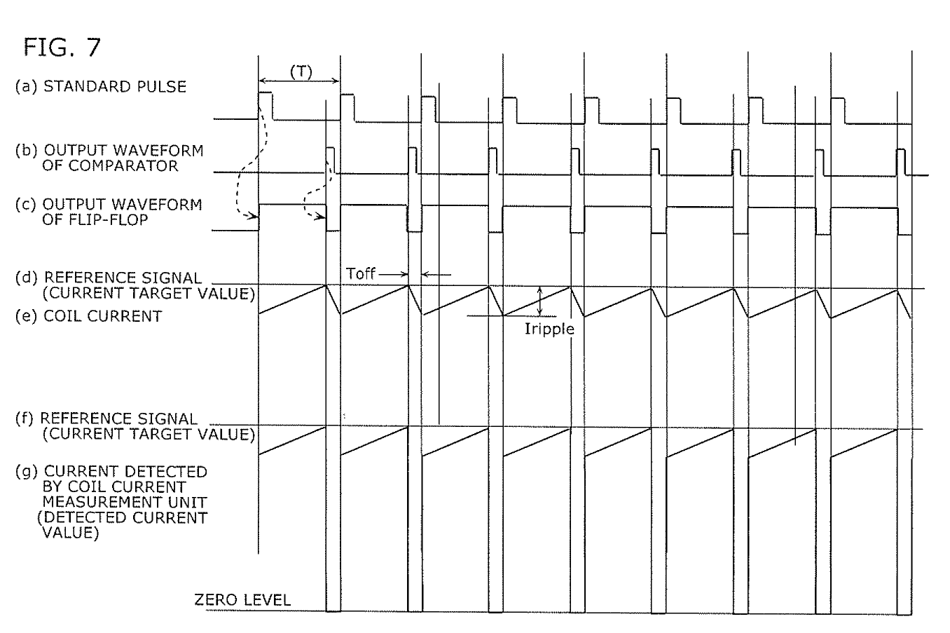

A stepping motor drive apparatus according to the first embodiment of the present invention is explained with reference to FIGS. 3 to 7. FIG. 3 is a block diagram showing a construction of the stepping motor drive apparatus of the present embodiment. FIG. 4 is a diagram showing waveforms generated by the stepping motor drive apparatus of the present embodiment. FIGS. 5A and 5B are diagrams showing current paths of the stepping motor drive apparatus of the present embodiment. FIG. 6 is a diagram showing an example of a coil current measurement unit of the present embodiment. FIG. 7 is a diagram showing waveforms generated by an ideal stepping motor drive apparatus.

It should be noted here that each coil provided for a stepping motor 2 of the stepping motor drive apparatus has the same set of components. Therefore, only the components provided for a coil 3 of the stepping motor 2 is explained and other coils and the components provided for these coils will not be illustrated or explained in the present and following embodiments of this specification.

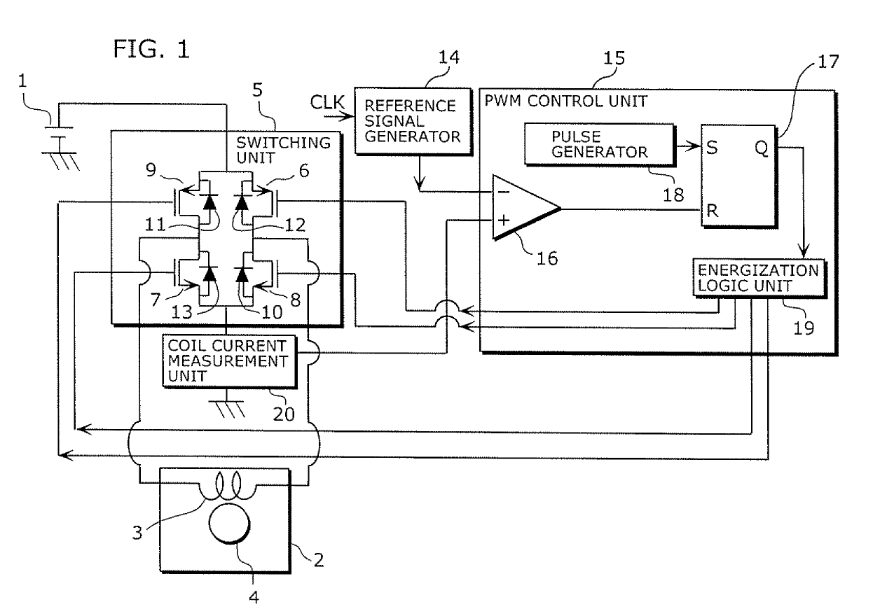

As shown in FIG. 3, the stepping motor drive apparatus of the first embodiment is composed of: a power source 1; a stepping motor 2 that is a controlled object having a coil 3 and a rotator 4; a switching unit 5 for controlling a current to be supplied to the coil 3; a reference signal generator 14 for generating a reference signal showing a current limit value; a PWM control unit 15a; a coil current measurement unit 20; and a timer unit 31. The switching unit 5 has transistors 6 to 9 and flywheel diodes 10 to 13, which form current supply paths to the coil 3. The PWM control unit 15a has a comparator 16, a flip-flop 17, a pulse generator 18, an energization logic unit 19, and an OR gate 30. This construction is different from the construction of the conventional stepping motor drive apparatus shown in FIG. 1 in that the OR gate 30 and the timer unit 31 are added.

The OR gate 30 carries out the logical OR between an output signal from the comparator 16 and an output signal (described later as a completion signal) from the timer unit 31, and then outputs the result to a reset terminal of the flip-flop 17. At the point in time when a detected current value exceeds a current target value or when the timer unit 31 has finished measuring a predetermined period of time, the OR gate 30 resets the flip-flop 17.

The timer unit 31 measures the predetermined period of time which is shorter than a PWM cycle T, and outputs a pulse signal as the completion signal to indicate that the measurement has been completed.

The stepping motor drive apparatus according to the first embodiment of the present invention performs pulse-width modulation control (referred to as the “PWM control” hereafter) so that the mean value of the current to be supplied to the coil 3 is asymptotic to the current limit value generated by the reference signal generator 14. To be more specific, the PWM control is performed by the current chopper method.

First, an explanation is given as to the reference signal generated by the reference signal generator 14. The reference signal generator 14 generates a staircase reference signal that rises and falls with a stepwise motion, and then outputs the waveform as a current limit value to the comparator 16. Here, as a result of the rise or fall of the current limit value with a stepwise motion, the stepping motor 2 rotates a specific number of degrees in rotation. The stepping process for the current limit value is controlled by an input CLK (clock) in the present embodiment. Note that the effect of the present invention can be also achieved by the construction where the stepping process is controlled on the basis of the measurement of an interval between the steps by the timer unit 31. In the present embodiment, a cycle of a stepping process is determined by an input CLK cycle or a timer cycle that determines the interval between the steps. This cycle of a stepping process for the current limit value, in turn, determines a cycle in which the stepping motor 2 rotates the specific number of degrees and, by extension, determines a rotation cycle of the stepping motor 2. It is desirable that the current limit value is outputted as a sinusoidal signal from the perspective of low noise and low vibration. Hence, the reference signal generator 14 generates a staircase waveform by sampling a sinusoidal waveform. In the stepping processes, values obtained by sampling the sinusoidal waveform are outputted one at a time for each step. In this way, a staircase waveform generated by sampling the sinusoidal waveform is outputted. Here, in order to avoid abrupt current variations due to the stepwise motion, the staircase waveform is first smoothed out by an integrator, such as a low-pass filter. Then, the sinusoidal reference signal obtained as a result is outputted as the current limit value to the comparator 16. It should be noted here that the staircase waveform is not necessarily generated by sampling a sinusoidal waveform. In consideration of the physical package space, it is possible to use a staircase waveform which is generated by sampling an approximate sinusoidal waveform or which is a non-sinusoidal waveform. Also, in the case where the abrupt current variations due to the stepwise motion are allowable, the staircase waveform that is not smoothed out may be outputted to the comparator 16.

The PWM control unit 15a performs PWM control on the current passing through the coil 3, i.e., the coil current. The following is a detailed explanation of a PWM control operation performed by the PWM control unit 15a. FIG. 4 shows time variations of major signals relating to the PWM control operation, in addition to the current waveforms generated by the stepping motor drive apparatus.

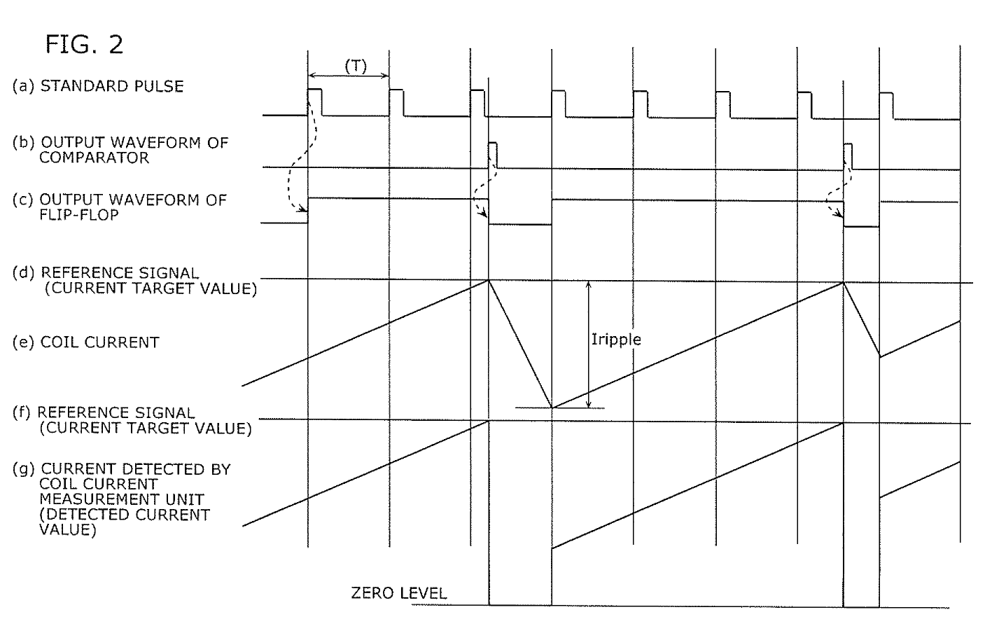

The pulse generator 18 outputs a signal for instructing to start a supply of current to the coil 3 at a fixed time interval, i.e., for each PWM cycle T, to a set terminal of the flip-flop 17 as shown in FIG. 2 (a). By this output signal, the flip-flop 17 is set for each PWM cycle T. Upon the set of the flip-flop 17, the energization logic unit 19 which receives an output signal from the flip-flop 17 sends a gate signal to each of the transistors 6 to 9 so as to bring the transistor into or out of conduction. Here, the transistor 6 or 9 is brought into conduction with the transistor 7 or 8, on the basis of a combination of the transistors as well as timing whereby a through current does not flow from the power source 1 to the ground. Then, the current supply to the coil 3 is started, so that the coil current starts increasing as shown in FIG. 4 (g). In this way, each time the pulse generator 18 generates the signal at the fixed time interval, i.e., the signal to begin the PWM cycle T, the current supply to the coil 3 is started and the coil current state is caused to transition to the PWM ON period. Thus, the fixed time interval established by the pulse generator 18 serves as the PWM cycle.

FIG. 5A shows a current path 40 of the case where the gate signal for bringing a transistor into conduction is sent to the transistors 6 and 7 while the gate signal for bringing a transistor out of conduction is sent to the transistors 8 and 9 during the PWM ON period. As shown, a current is supplied from the power source 1 to the coil 3 by the current flowing from the power source 1 to the transistor 6, the coil 3, the transistor 7, the coil current measurement unit 20, then to the ground in this order. Here, in the present embodiment, the coil current measurement unit 20 is placed between the switching unit 5 and the ground so as to detect the current which flows to the ground via the coil current measurement unit 20. Note that the coil current measurement unit 20 may be placed between the power source 1 and the switching unit 5 so as to detect the current that flows from the power source 1 to the switching unit 5 via the coil current measurement unit 20. With this construction, the effect of the present invention can be also achieved.

Upon the set of the flip-flop 17, the timer unit 31 which receives an output signal from the flip-flop 17 resets the time measured so far and newly starts the time measurement. Then, when the predetermined period of time has elapsed, the timer unit 31 outputs the completion signal to the OR gate 30. In the present embodiment, the timer unit 31 resets the time measured so far when the flip-flop 17 is set, as shown in FIG. 4. However, at the point of time when the flip-flop 17 is reset, the timer unit 31 may reset the measured time and stop measuring. Then, when the flip-flop 17 is set, the timer unit 31 may start the time measurement.

As described above, the coil current flowing through the current path 40 shown in FIG. 5A is detected by the coil current measurement unit 20, which then outputs the detected current value to the comparator 16. FIG. 6 is a schematic circuit diagram showing a construction of the coil current measurement unit 20.

The coil current measurement unit 20 is composed of a detection resistor 41, a sense amplifier 42, and gain setting resistors 43 and 44. The coil current passing through the current path 40 flows to the ground via the detection resistor 41. Here, a voltage generated across a terminal of the detection resistor 41 is inputted to a non-inverting input terminal of the sense amplifier 42. A voltage gain from input to output of the sense amplifier 42 is set by the gain setting resistors 43 and 44. A voltage obtained by multiplying by the voltage gain inputted into the non-inverting input terminal is outputted from the sense amplifier 42 to the comparator 16, as the detected value of the coil current.

In this way, the current target value and the detected current value are inputted to the comparator 16 respectively from the reference signal generator 14 and the coil current measurement unit 20. The comparator 16 compares the current target value and the detected current value. Then, at the point in time when the detected current value exceeds the current target value, the comparator 16 resets the flip-flop 17 via the OR gate 30 as shown in FIG. 4 (b). This reset of the flip-flop 17 causes the coil current state to transition to the PWM OFF period as shown in FIGS. 4 (d), (e), and (9).

Note that, as shown at a time (A) in FIG. 4, when the timer unit 31 has finished measuring the predetermined period of time (that is shorter than the PWM cycle) and outputs the completion signal to the OR gate 30 before the detected current value is detected to exceed the current target value, the flip-flop 17 is reset via the OR gate 30 so that the coil current state is caused to transition to the PWM OFF period without relying on the current detection. This transition to the PWM OFF period owing to the timer unit 31 is one of the features of the present invention. To be more specific, even in the case where the detected current value would continue to be below the current target value for a plurality of PWM cycles, the flip-flop 17 is reset on completion of the time measurement by the timer unit 31. As described earlier, the predetermined period of time is shorter than the PWM cycle T. Thus, this operation of the timer unit 31 allows the coil current state to transition to the PWM OFF period, meaning that the maximum length of the PWM ON period is limited and that the PWM ON period will never continue for a plurality of PWM cycles. In other words, the maximum duty of the PWM control is limited by the timer unit 31.

Accordingly, the first problem mentioned above is solved. To be more specific, the PWM ON period is prevented from continuing for a plurality of PWM cycles and therefore the decrease in the frequency of the current waveform is also prevented.

Although the OR gate 30 is used in the present embodiment, the type of the logic gate can be changed by changing the polarity of the signal. The idea of the present invention is to cause the coil current state to transition from the PWM ON period to the PWM OFF period at the point in time when the detected current value exceeds the current limit value or when the timer unit 31 outputs the completion signal. Thus, as long as the operation is carried out as intended, the same effect as in the present embodiment can be achieved in the case where the OR gate is replaced with a NOR gate, an AND gate, or a NAND gate.

Moreover, in the present embodiment, the transition to the PWM ON period is caused by the set of the flip-flop 17 and the transition to the PWM OFF period is caused by the reset of the flip-flop 17. In this operative relation, the set and reset of the flip-flop 17 can be reversed. More specifically, the same effect as in the present embodiment can be also achieved in the case where the transition to the PWM ON period is caused by the reset of the flip-flop 17 and the transition to the PWM OFF period is caused by the set of the flip-flop 17.

Here are additional details on the detected current value. Immediately after the transition to the PWM ON period, there may be a current “overshoot” in the detected current. This overshoot is caused mainly when a discharging current of a parasitic capacitance of the switching unit 5, e.g. a current that discharges the parasitic capacitance present between a drain and a gate of the transistor 7, flows to the coil current measurement unit 20. Due to this overshoot, there may be a case where the coil current measurement unit 20 and the comparator 16 incorrectly detect that the coil current has exceeded the current target value although it has not actually. In order to avoid this error, the current detection by the coil current measurement unit 20 and the comparator 16 is masked for a given period of time during which the overshoot is likely to be occurring. Hereafter, the period of time during which the current detection is masked is referred to as the “mask time”. To carry out the mask of the current detection in the present embodiment, a set-priority flip-flop is used as the flip-flop 17 and a pulse width of a signal outputted from the pulse generator 18 is set corresponding to the mask time. More specifically, as long as the pulse generator 18 outputs the signal with the pulse width corresponding to the mask time, the set-priority flip-flop 17 will not be reset even when the comparator 16 detects the incorrect current value due to the overshoot. Moreover, in order to achieve the same effect as in the present embodiment, the output of the coil current measurement unit 20 or the output of the comparator 16 may be fixed during the mask time.

Next, an explanation is given as to the reset operation performed on the flip-flop 17. In the present embodiment, by the reset of the flip-flop 17, the energization logic unit 19 supplies the gate signal to the transistors 7 and 8 to drive them into cutoff. By the cutoff of both the transistors 7 and 8, the coil current state is caused to transition to the PWM OFF. Then, as the current supply to the coil 3 is interrupted, the coil current starts decreasing due to the current flow circulation.

FIG. 5B shows the current path 40 during the PWM OFF period in the case where the transistors 6 and 7 were conducting immediately before the transition to the PWM OFF period took place. As shown, the coil current circulates via the flywheel diode 11 and the transistor 6, and then accordingly decreases.

It should be noted that the flywheel diodes 10 to 13 provided in the present embodiment may be replaced with body diodes each of which is composed of a back gate and a drain of the corresponding one of the transistors 6 to 9. Moreover, for the purpose of reducing the decrease in the coil current during the PWM OFF period, Schottky barrier diodes may be used as the flywheel diodes 10 to 13.

After the transition to the PWM OFF period by the reset of the flip-flop 17, the above operation is repeated every time the pulse generator 18 sets the flip-flop 17 at the fixed time interval. By the alternation of the current increase during the PWM ON period and the current decrease during the PWM OFF period, the mean current supplied to the coil 3 is asymptotic to the current target value.

The following is a description about prevention of an increase in the current ripple, which was mentioned earlier as the second problem.

In the case of the conventional stepping motor drive apparatus described above, the amount of decrease in the coil current is at the maximum when the length of the PWM OFF period is equivalent to the length of the PWM cycle T. Here, when an inductance value of the coil 3 is represented as “L” and a voltage applied to the coil 3 during the PWM OFF period as “Voff”, the maximum amount of decrease is given by the expression (Voff/L)·T.

In the present embodiment, the amount of decrease in the coil current is at the maximum under the following condition.

Condition: In the PWM control performed one cycle before, the transition to the PWM OFF period is caused by the timer unit 31 and by the comparator 16 simultaneously.

To be more specific, the timer unit 31 outputs the completion signal at the same time as when the current value detected by the coil current measurement unit 20 exceeds the current limit value inputted by the reference signal generator 14. This phenomenon is shown at a time (B) in FIG. 4. Under the above condition, the length of the PWM ON period is at the maximum and the coil current reaches the current target value. The PWM OFF period is given by subtracting the PWM ON period from the PWM cycle T. This means that when the PWM ON period is at the maximum, the PWM OFF period is at the minimum. Thus, the PWM OFF period at the time (B) shown in FIG. 4 is at the minimum. In FIG. 4, this minimum length is shown as a minimum PWM OFF period 34. When the minimum PWM OFF period is represented as “Toff_min”, the PWM cycle as “T” and the maximum PWM ON period shown as a time period 33 that is measured by the timer unit 31 as “Ttimer” the minimum PWM OFF period Toff_min is expressed by the following equation:
Toff_{—}min=(T-Ttimer) Equation 1

Under the above condition, at the point in time of the transition to the PWM OFF period, that is, at the time (B) in FIG. 4, the value of the coil current is equivalent to the current target value and the amount of current decreased during the minimum PWM OFF period 34 is a difference that can be obtained by measuring with respect to the current target value from the position at which the transition to the PWM ON period takes place again. Here, the amount of current decreased during the minimum PWM OFF period 34 is at the minimum because the length of the period is also at the minimum. When this minimum amount of decrease in current is represented as “Idrop”, the inductance value of the coil 3 as “L”, and the voltage applied to the coil 3 during the PWM OFF period as “Voff”, Idrop is approximated by the following equation:
Idrop=(Voff/L)·Toff_{—}min Equation 2

As mentioned above, when the transition to the PWM ON period takes place following the minimum PWM OFF period 34, the amount of decrease in current here is Idrop, which is at the minimum as the difference with respect to the current target value. Therefore, after the transition to the PWM ON period, a period of time taken until the detected current value exceeds the current target value inputted by the reference signal generator 14 is also at the minimum. This minimum period is shown as a minimum PWM ON period 35 at a time (C) in FIG. 4. When the minimum PWM ON period is represented as “Ton_min” and a voltage applied to the coil 3 during the PWM ON period as “Von”, Ton_min is approximated by the following equation:
Ton_{—}min=(Idrop·L)/Von Equation 3

As described above, the PWM OFF period is given by subtracting the PWM ON period from the PWM cycle T. This means that when the PWM ON period is at the minimum, the PWM OFF period is at the maximum. Thus, the PWM OFF period at the time (C) shown in FIG. 4 is at the maximum. In FIG. 4, this maximum period is shown as a maximum PWM OFF period 36. When the maximum PWM OFF period is represented as “Toff_max”, this Toff_max is expressed by the following equation:
Toff_{—}max=(T−Ton_{—}min) Equation 4

The amount of decrease in the coil current is at the maximum when the PWM OFF period is equivalent to the maximum PWM OFF period 36. Here, when a maximum amount of decrease in the coil current is represented as “Iripple”, this Iripple is approximated by the following equation:
Iripple=(Voff/L)·Toff_{—}max Equation 5

Moreover, the maximum amount of decrease in the coil current represented as Iripple is expressed by the following equation, according to above Equations 1 to 5:
Iripple=[(Voff/L)·T]−[(T−Ttimer)·Voff·Voff/Von/L] Equation 6

In the case of the conventional stepping motor drive apparatus, the amount of current decrease is expressed as [(Voff/L)·T]. As can be understood, the amount of current expressed as the current ripple by the term [(T-Ttimer)·Voff·Voff/Von/L] of Equation 6 is reduced as compared with the conventional case. Thus, the increase in the current ripple, which is described as the second problem earlier in the present specification, can be accordingly prevented.

In the present embodiment, the explanation has been given for the case of the so-called downside chopper operation where the transistors 7 and 8 are brought into cutoff. However, the same effect as in the present invention can be also achieved in the case of the so-called upside chopper operation where the transistors 6 and 9 are brought into cutoff.

According to the present embodiment as described so far, the first and second problems are solved. To be more specific, the PWM ON period is prevented from continuing for a plurality of PWM cycles, so that a decrease in the frequency of the current waveform is accordingly prevented. Moreover, an increase in the current ripple can be prevented. On account of these solutions, the stepping motor drive apparatus according to the present embodiment can operate with low noise and low vibration.

Since an operation close to ideal as shown in FIG. 7 can be performed, the decrease in the frequency of the current waveform is prevented and the increase in the current ripple is also prevented according to the present embodiment. Here, when using an ideal stepping motor drive apparatus, the PWM ON period and the PWM OFF period alternate at a fixed duty within the PWM cycle T. For example, the PWM ON period occupies 80% of the PWM cycle T whereas the PWM OFF period occupies the remaining 20%.

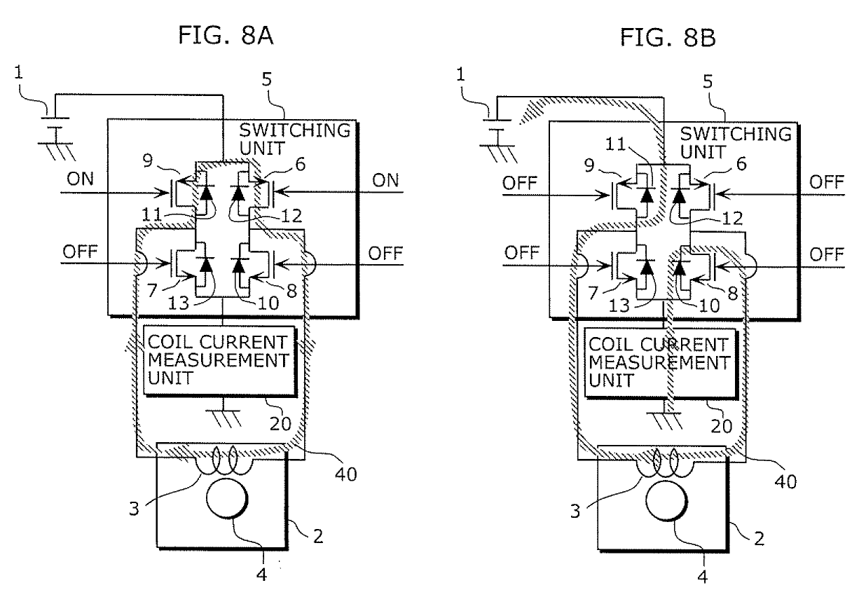

Although the current path 40 used during the PWM OFF period is shown in FIG. 5B in the present embodiment, the current path is not limited to this. For example, as shown by the current path 40 in FIG. 8A, it is possible to bring the transistors 6 and 9 into conduction during the PWM OFF period for the purpose of reducing the decrease in the coil current as well as reducing the current ripple. In this case, the power consumption by the flywheel diode 11 is replaced with the power consumption by the ON resistance of the transistor 9. Since the power consumption is accordingly reduced, the decrease in the coil current during the PWM OFF period is also reduced. In the case shown in FIG. 8A, the coil current circulates via the transistors 6 and 9, and then accordingly decreases. Moreover, as shown by the current path 40 in FIG. 8B, it is possible to bring the transistors 6 and 9 out of conduction during the PWM OFF period for the purpose of quickly reducing the coil current. In the case shown in FIG. 8B, the coil current circulates via the flywheel diodes 10 and 11, and the accordingly decreases.

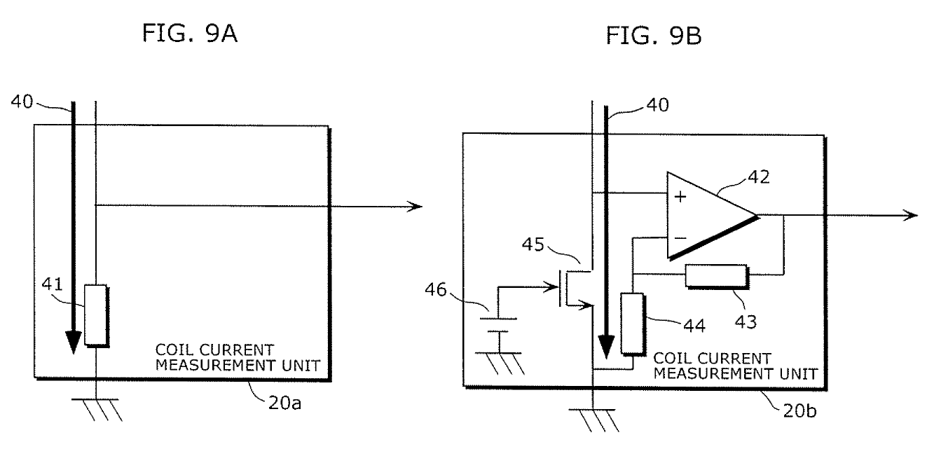

Moreover, although the coil current measurement unit 20 has the construction as shown in FIG. 6 in the present embodiment, the unit 20 is not limited to this circuit. For example, it may be a simple circuit that does not have the sense amplifier 42 as shown by a coil current measurement unit 20a in FIG. 9A. This current measurement unit 20a detects the coil current by a voltage drop across the detection resistor 41. Moreover, as shown by a coil current measurement unit 20b in FIG. 9B, it is possible to use the ON resistance of a MOS (Metal Oxide Semiconductor) transistor 45 that occurs when a gate application voltage 46 is given, so that the same effect as in the case of the detection resistor 41 can be achieved. As should be understood, it is possible to have the construction without the sense amplifier 42 as in the case of the coil current measurement unit 20a shown in FIG. 9A and also use the ON resistance of the MOS transistor 45 that occurs when the gate application voltage 46 is given as in the case shown in FIG. 9B.

### Second Embodiment

The following is a description of the present invention according to the second embodiment.

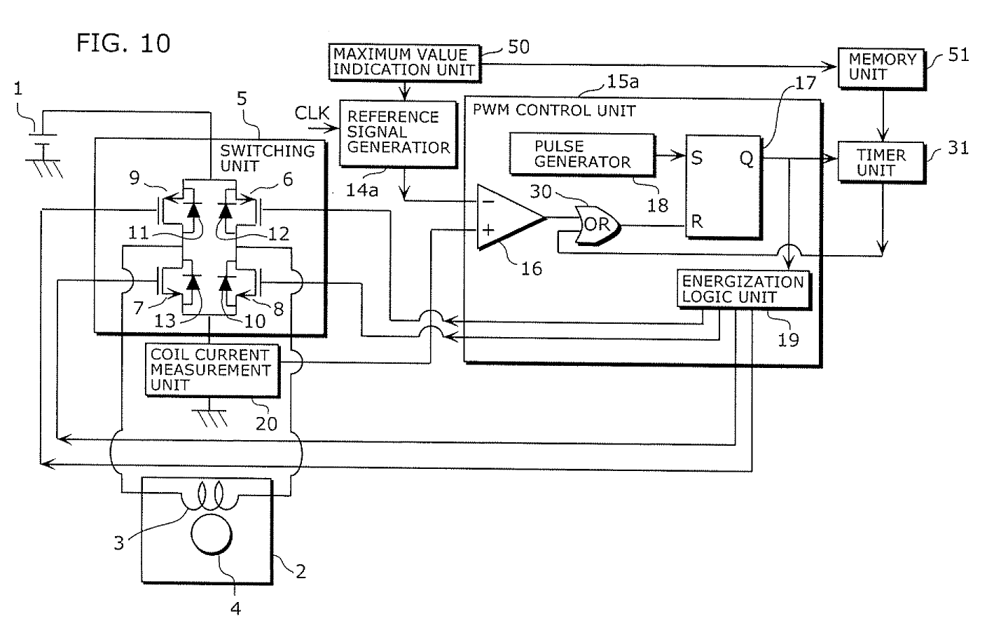

A stepping motor drive apparatus according to the second embodiment of the present invention is different from the stepping motor drive apparatus of the first embodiment in that a period of time measured by the timer unit 31 until the output of completion signal is selected from a memory unit corresponding to a maximum value of the current limit value shown by a reference signal. Hereafter, the maximum value of the current limit value is referred to as the “maximum current target value”. In the second embodiment, an explanation is mainly given as to differences from the first embodiment, with reference to FIGS. 10 to 12. Note that the same operations as in the first embodiment are not repeated here.

FIG. 10 is a block diagram showing a construction of the stepping motor drive apparatus according to the second embodiment of the present invention. The stepping motor drive apparatus is composed of: a power source 1; a stepping motor 2 that is a controlled object having a coil 3 and a rotator 4; a switching unit 5 for controlling a current to be supplied to the coil 3; a reference signal generator 14a for generating a reference signal showing a current limit value; a PWM control unit 15a; a coil current measurement unit 20; a timer unit 31; a maximum value indication unit 50; and a memory unit 51. The switching unit 5 has transistors so 6 to 9 and flywheel diodes 10 to 13, which form current supply paths to the coil 3. The present stepping motor drive apparatus is different from the apparatus of the first embodiment in that the reference signal generator 14 is replaced with the reference signal generator 14a and that the maximum value indication unit 50 and the memory unit 51 are added.

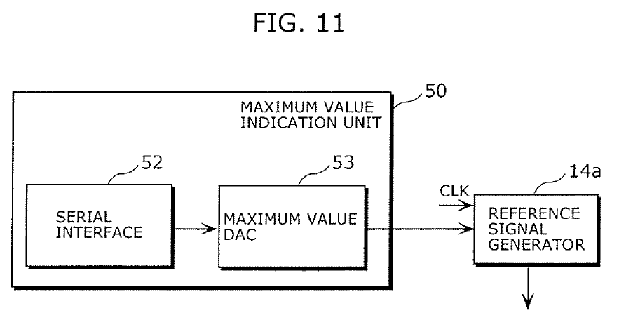

The maximum value indication unit 50 indicates the maximum current target value to the reference signal generator 14a and the memory unit 51, and has a serial interface 52 and a maximum value DAC (Digital-to-Analog Converter) 53 as shown in FIG. 11. The serial interface 52 outputs a code specifying the maximum current target value generated by the reference signal generator 14a to the maximum value DAC 53, according to control by a microcomputer or a command from a user. Then, the maximum value DAC 53 outputs the maximum current target value specified by the serial interface 52 to the reference signal generator 14a and the memory unit 51.

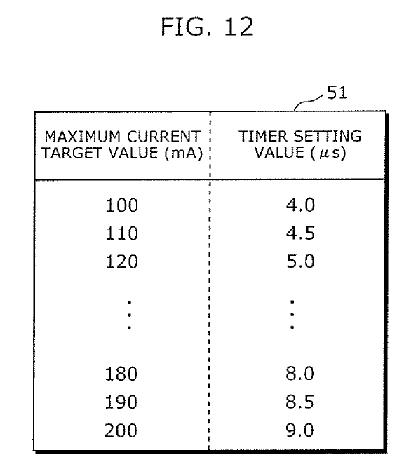

The memory unit 51 is a memory or the like which stores a table showing a correspondence between the maximum current target value and a timer setting value which is a period of time to be preset to the timer unit 31. For each maximum current target value outputted by the maximum value indication unit 50, the memory unit 51 stores a duty required to supply the coil 3 with the current corresponding to the maximum current target value. Here, the duty refers to a time limit of the PWM ON period that is indicated as the “timer setting value” in FIG. 12. When receiving the maximum current target value or the code specifying the maximum current target value from the maximum value indication unit 50, the memory unit 51 outputs the value or the timer setting value corresponding to the code, to the timer unit 31. It should be noted that the table held by the memory unit 51 is so formed that the maximum duty of the PWM control is large when the maximum current target value is large and that the maximum duty of the PWM control is small when the maximum current target value is small, as shown in FIG. 12.

The reference signal generator 14a generates a staircase waveform by sampling a sinusoidal wave that has the maximum current target value outputted from the maximum value indication unit 50 (the maximum value DAC 53, to be more precise) as a peak value. Then, the reference signal generator 14a outputs the staircase waveform or a voltage obtained after smoothing out the staircase waveform as the reference signal showing the current limit value, to the comparator 16.

The features of the stepping motor drive apparatus of the second embodiment having this construction are as follows. Using the stepping motor drive apparatus of the first embodiment, the current ripple expressed in the term [(T−Ttimer)·Voff·Voff/Von/L] of Equation 6 is reduced. This means that the current ripple can be further reduced by shortening Ttimer measured by the timer unit 31, i.e., by setting the maximum duty of the PWM control smaller. However, when the maximum duty of the PWM control is set smaller, this means the maximum amount of current supplied to the coil 3 is to be limited. On account of this, the maximum duty cannot be set below a duty that is required to supply the coil 3 with a current corresponding to the current target value. Thus, when the maximum current target value varies among a plurality of different values, the time measured by the timer unit 31, i.e., Ttimer, needs to be set corresponding to the duty required to supply the maximum current which is represented by the maximum value out of the plurality of the different values. Therefore, an appropriate setting cannot be executed to lower current values, meaning that the current ripple cannot be reduced with the utmost efficacy. In consideration of this problem, the object of the present embodiment is to provide an appropriate setting for the plurality of the maximum current target values. The following is a description of an operation performed by the stepping motor drive apparatus of the second embodiment.

First, an explanation is given as to the current target value generated by the maximum value indication unit 50 and the reference signal generator 14a. The maximum value indication unit 50 outputs the maximum current target value specified by the serial interface 52 to the reference signal generator 14a. The reference signal generator 14a generates a staircase waveform by sampling a sinusoidal wave that has the maximum current target value outputted from the maximum value DAC 53 as a peak value. In order to avoid abrupt current variations due to the stepwise motion, the staircase waveform is smoothed out by an integrator, such as a low-pass filter. Then, the sinusoidal waveform obtained as a result is outputted as a reference signal showing a current limit value, to the comparator 16. It should be noted here that the staircase waveform is not necessarily generated by sampling the sinusoidal waveform. In consideration of the physical package space, it is possible to use a staircase waveform which is generated by sampling an approximate sinusoidal waveform or which is a non- sinusoidal waveform. Also, in the case where the abrupt current variations due to the stepwise motion are allowable, the staircase waveform that is not smoothed out may be outputted to the comparator 16. Although the maximum value indication unit 50 has the serial interface 52 and the maximum value DAC 53 in the present embodiment, the same effect as in the present embodiment can be also achieved in the case where the serial interface 52 may output a code specifying the maximum current target value directly to the reference signal generator 14a. Moreover, although the serial interface is used as a means of operating according to the control by the microcomputer or the command from the user, the same effect as in the present embodiment can be also achieved in the case where a different type of interface is used. Furthermore, instead of the DAC that is used as a means of outputting the specified maximum current target value, a different component may be used as long as the component can output the maximum value specified by the interface. With this construction, the same effect as in the present embodiment can also be achieved.

Next, an explanation is given as to a period of time measured by the timer unit 31 until the output of the completion signal. The memory unit 51 outputs the time limit of the PWM ON period corresponding to the maximum current target value outputted from the maximum value indication unit 50, to the timer unit 31. Thus, optimization can be so performed that the maximum duty of the PWM control is set large when the maximum current target value is large and the maximum duty of the PWM control is set small when the maximum current target value is small.

In the present embodiment, the memory unit 51 is constructed as the table that shows a correspondence between the maximum current target value and the time limit of the PWM ON period. However, the same effect as in the present embodiment can also be achieved in the case where the memory unit 51 holds an equation where the maximum current target value is an input and then outputs the time limit of the PWM ON period as a result of the calculation. As one example of the equation, when the power source voltage is represented as “V”, a path resistance during the PWM ON period as “R”, the input maximum current target value as “Imax”, the output time limit of the PWM ON period as “Ton”, the PWM cycle as “T”, and a margin factor corresponding to variations as “═”, the equation is expressed as: [Ton=α·Imax·T·R/V]. It is obvious that the equation is not limited to this. The same effect as in the present invention can also be achieved using a different equation as long as the time limit of the PWM ON period that allows the current corresponding to the input maximum current target value to be supplied to the coil 3 is outputted according to the equation.

The timer unit 31 measures the time limit of the PWM ON period inputted from the memory unit 51, and outputs the completion signal when finishing the measurement. When the coil current state has not transitioned to the PWM OFF period at the time of the output of the completion signal, the timer unit 31 causes the transition to the PWM OFF period to take place.

In addition to the effect achieved in the first embodiment, the operation described in the second embodiment can optimize the effect of preventing the increase in the current ripple in the case where the maximum current target value varies among the plurality of values. Accordingly, the stepping motor drive apparatus of the present embodiment can operate with lower noise and lower vibration.

### Third Embodiment

The following is a description of the third embodiment of the present invention.

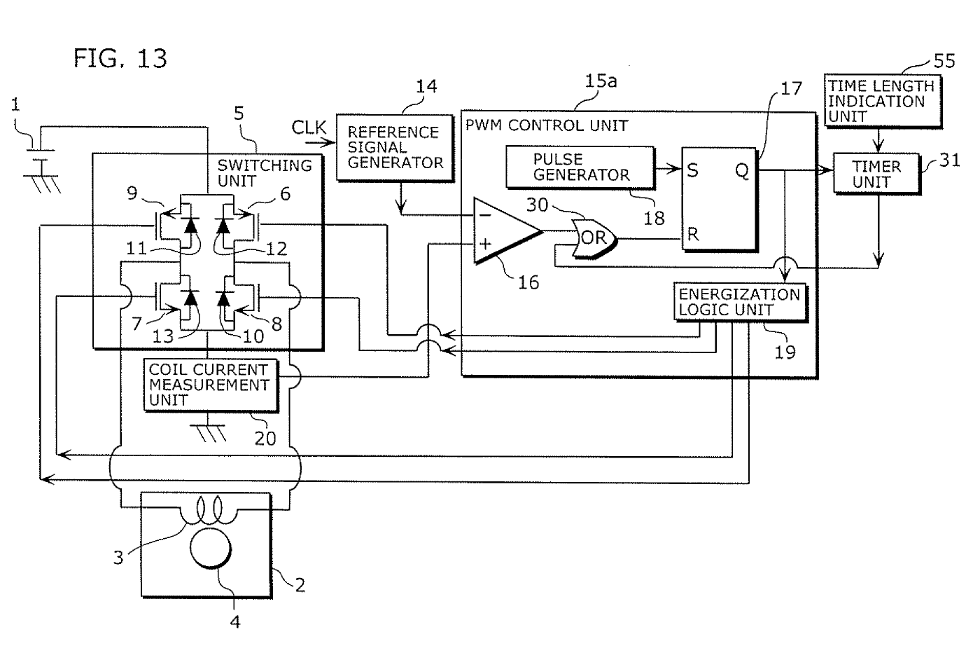

A stepping motor drive apparatus according to the third embodiment is different from the stepping motor drive apparatus according to the first embodiment in that a period of time measured by the timer unit 31 until the output of the completion signal is specified arbitrarily and precisely according to control by a microcomputer or a command from the user. In the third embodiment, an explanation is mainly given as to differences from the first embodiment, with reference to FIG. 13. Note that the same operations as in the first embodiment are not repeated here.

FIG. 13 is a block diagram showing a construction of the stepping motor drive apparatus according to the third embodiment of the present invention. The stepping motor drive apparatus is composed of: a power source 1; a stepping motor 2 that is a controlled object having a coil 3 and a rotator 4; a switching unit 5 for controlling a current to be supplied to the coil 3; a reference signal generator 14 for generating a reference signal showing a current limit value; a PWM control unit 15a; a coil current measurement unit 20; a timer unit 31; and a time length indication unit 55. The switching unit 5 has transistors 6 to 9 and flywheel diodes 10 to 13, which form current supply paths to the coil 3. The present stepping motor drive apparatus is different from the apparatus of the first embodiment shown in FIG. 3 in that the time length indication unit 55 is added.

The time length indication unit 55 is a serial interface or the like that receives control from a microcomputer or a command from a user regarding a setting value (i.e., a timer setting value showing a period of time shorter than the PWM cycle) of the timer unit 31, and outputs (or, indicates) the timer setting value corresponding to the received control or command, to the timer unit 31.

The features of the stepping motor drive apparatus of the third embodiment having this construction are as follows. Using the stepping motor drive apparatus of the first embodiment in the case where the maximum target value varies among the plurality of different values, Ttimer measured by the timer unit 31 needs to be set corresponding to the duty required to supply the maximum current which is represented by the maximum value out of the plurality of the different values. Therefore, an appropriate setting cannot be executed to lower current values, meaning that the current ripple cannot be reduced with the utmost efficacy. In consideration of this problem, the object of the present embodiment is to provide an appropriate setting for the plurality of the maximum current target values. The following is a description of an operation performed by the stepping motor drive apparatus of the third embodiment.

An explanation is given as to a time length that is outputted from the time length indication unit 55. The time length indication unit 55 outputs a time length to be measured until the output of the completion signal, to the timer unit 31. That is, a timer setting value is outputted from the time length indication unit 55. Here, when the maximum current target value is large, the time length indication unit 55 outputs such a time length that allows the maximum duty of the PWM control to be large. Meanwhile, when the maximum current target value is small, the time length indication unit 55 outputs such a time length that allows the maximum duty of the PWM control to be small. This time length is outputted from the time length indication unit 55 as a result of a calculation by the microcomputer or a setting by the user. In this way, the time length to be measured by the timer unit 31 until the output of the completion signal is specified arbitrary and precisely. As is the case with the second embodiment, the effect of reducing the current ripple can be precisely optimized for all of the maximum current target values.

Although the serial interface is used as a means of operating according to the control by the microcomputer or the command from the user, the same effect as in the present embodiment can be achieved in the case where a different type of interface is used.

In addition to the effect achieved in the first embodiment, the operation described in the third embodiment can precisely optimize the effect of preventing the increase in the current ripple in the case where the maximum current target value varies among the plurality of values. Consequently, the stepping motor drive apparatus of the present embodiment can operate with lower noise and lower vibration.

### Fourth Embodiment

The following is a description of the fourth embodiment of the present invention.

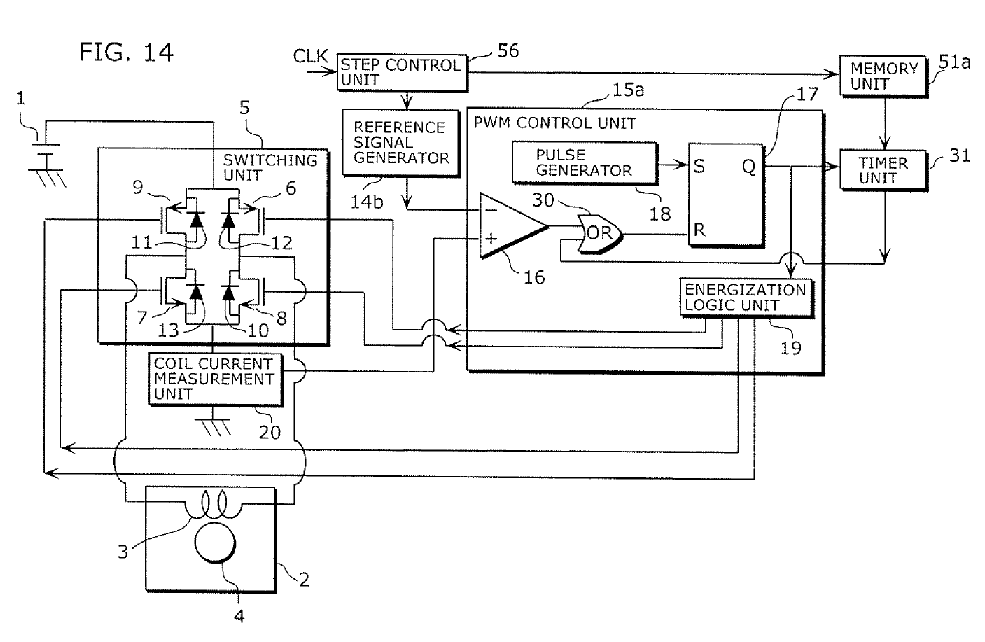

A stepping motor drive apparatus according to the fourth embodiment is different from the stepping motor drive apparatus according to the first embodiment in that a period of time measured by the timer unit 31 until the output of the completion signal is selected from a memory unit, corresponding to a drive step of a stepping motor. In the fourth embodiment, an explanation is mainly given as to differences from the first embodiment, with reference to FIGS. 14 to 17. Note that the same operations as in the first embodiment are not repeated here.

FIG. 14 is a block diagram showing a construction of the stepping motor drive apparatus according to the fourth embodiment of the present invention. The stepping motor drive apparatus is composed of: a power source 1; a stepping motor 2 that is a controlled object having a coil 3 and a rotator 4; a switching unit 5 for controlling a current to be supplied to the coil 3; a reference signal generator 14b for generating a reference signal showing a current limit value; a PWM control unit 15a; a coil current measurement unit 20; a timer unit 31; a step control unit 56; and a memory unit 51a. The switching unit 5 has transistors 6 to 9 and flywheel diodes 10 to 13, which form current supply paths to the coil 3. The present stepping motor drive apparatus is different from the apparatus of the first embodiment shown in FIG. 3 in that the reference signal generator 14 is replaced with the reference signal generator 14b and that the step control unit 56 and the memory unit 51a are added.

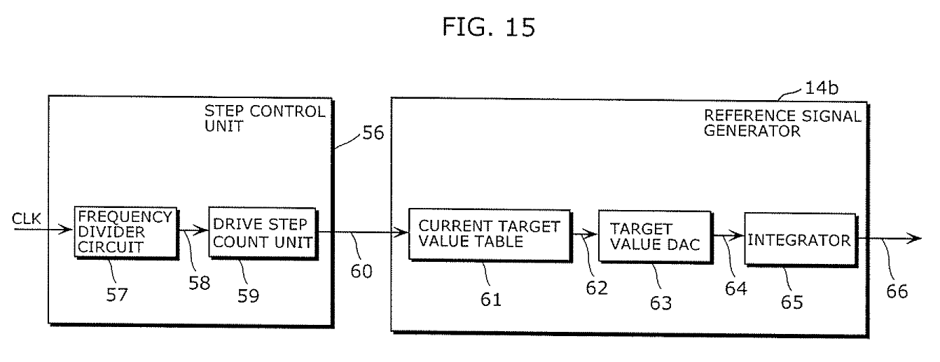

The step control unit 56 is a circuit that outputs a drive step signal showing a position in time in one cycle of the current target value to the reference signal generator 14b and the memory unit 51a at a fixed time interval. Here, in the case where one cycle is divided into 64 periods, for example, the position in time is indicates by a drive step value which represents one of the 64 periods. This position in time in one cycle is referred to as the “time position” hereafter. As shown in FIG. 15, the step control unit 56 has a frequency divider circuit 57 and a drive step count unit 59. A clock signal CLK showing a step progress of the current target value is inputted to the step control unit 56. Hereafter, the clock signal CLK inputted to the step control unit 56 is simply referred to as the “input CLK”. This input CLK is inputted to the frequency divider circuit 57, to be more precise. In general, the input CLK is faster than a cycle in which the step of the current target value progresses. For this reason, the frequency divider circuit 57 divides the input CLK to make it as the cycle in which the step of the current target value progresses and, as a result, outputs a drive CLK 58. It should be noted that in the case where the input CLK corresponds to the cycle in which the step of the current target value progresses, the frequency divider circuit 57 is not needed and the input CLK is outputted as the drive CLK 58. Even in this case, the same effect as in the present embodiment can be achieved. The drive CLK 58 is then inputted to the drive step count unit 59 Every time the drive CLK 58 is inputted, the drive step count unit 59 advances the step and outputs a step signal 60 as a signal showing the drive step value to the reference signal generator 14b and the memory unit 51a.

The reference signal generator 14b is a circuit that outputs a current target value corresponding to the step signal 60 outputted from the step control unit 56. As shown in FIG. 15, the reference signal generator 14b has a current target value table 61, a target value DAC 63, and an integrator 65.

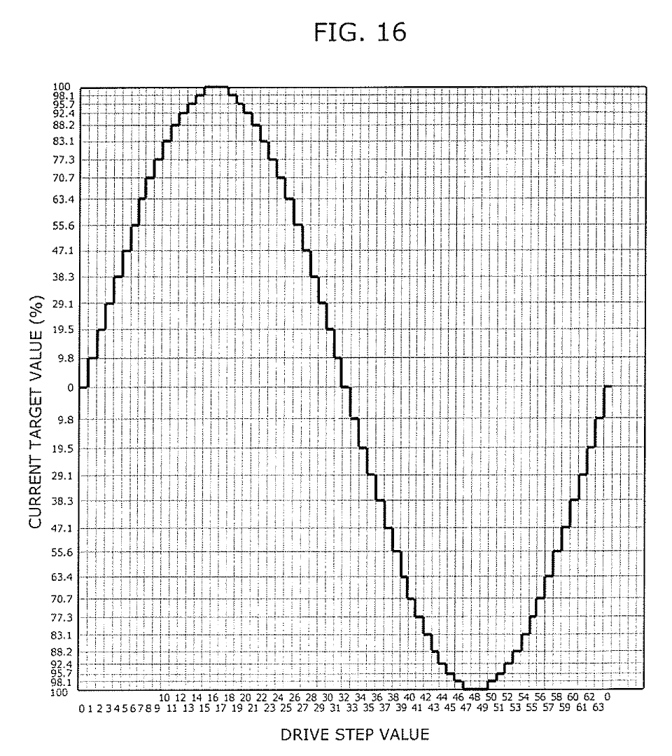

The step signal 60 inputted to the reference signal generator 14b is inputted as the signal showing the drive step value to the current target value table 61 that shows a current target value for each drive step value. As an example, FIG. 16 shows the current target values held in the current target value table 61. In the case shown in FIG. 16, the current target value table 61 holds values obtained by sampling a sinusoidal waveform as the current target values corresponding to the drive step values. To be more precise, the table 61 holds a code for generating a current target value for each drive step value in a subsequent stage of the circuit. For example, the table 61 holds the code such as a digital value representing the current target value or a command for selecting the current target value corresponding to the drive step value from among a plurality of current target values to be generated in the subsequent stage of the circuit. Note that the current target values held in the current target value table 61 are not limited to the values shown in FIG. 16. The same effect as in the present embodiment can be achieved in the case where the waveform is not sinusoidal but is square as long as a corresponding current target value is determined for each drive step value. Moreover, although the current target values are held as percentages with respect to the peak current value in FIG. 16, the same effect as in the present invention can be achieved in the case where the current target value table 61 holds the current target values as they are.

The current target value table 61 outputs a code for specifying the current target value corresponding to the step signal 60, to the target value DAC 63. Hereafter, this code is referred to as the specifying code 62. As mentioned above, one example of the specifying code 62 is a digital value representing the current target value corresponding to the step signal 60. In this case, the target value DAC 63 performs digital-to-analog conversion on the specifying code 62, and outputs this signal as a staircase waveform 64 of the current target value. Additionally, as also mentioned above, another example of the specifying code 62 is a command for selecting the current target value corresponding to the step signal 60 from among the plurality of current target values to be generated in the subsequent stage of the circuit. In this case, the target value DAC 63 generates the plurality of current target values corresponding to the drive steps, selects the current target value specified by the specifying code 62 from among the plurality of the values, and outputs the selected current target value as the staircase waveform 64. This stair-like form of the staircase waveform 64 results from discrete inputs to the target value DAC 63.

Here, in order to avoid abrupt current variations due to the stepwise motion, the staircase waveform 64 is first outputted to the integrator 65, such as a low-pass filter, which smoothes out the staircase waveform 64. Then, a sinusoidal reference signal 66 obtained as a result is outputted as the current target value. In the case where the abrupt current variations due to the stepwise motion are allowable, the integrator 65 is not needed and the staircase waveform 64 itself may be used as the reference signal 66.

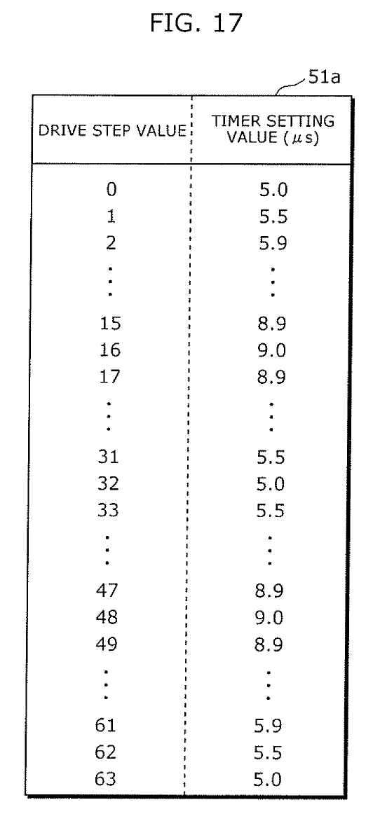

The memory unit 51a is a memory or the like that stores a table showing a correspondence between the drive step value shown by the step signal 60 indicated by the step control unit 56 and the timer setting value, as shown in FIG. 17. Here, the drive step values are integers 0 to 64, and each timer setting value represents a period of time that is shorter than the PWM cycle. The memory is unit 51a holds the table to show a duty, for each drive step value indicated by the step signal 60, that is required to supply the coil 3 with the current corresponding to the current target value. Here, the duty refers to a time limit of the PWM ON period, that is, a timer setting value to be set to the timer unit 31. Every time the step signal 60 is inputted, the memory unit 51a outputs the corresponding time limit of the PWM ON period, i.e. the timer setting value, to the timer unit 31.

The features of the stepping motor drive apparatus of the fourth embodiment having this construction are as follows. Using the stepping motor drive apparatus of the first embodiment, the current ripple expressed in the term [(T−Ttimer)·Voff·Voff/Von/L] of Equation 6 is reduced. This means that the current ripple can be further reduced by shortening Ttimer measured by the timer unit 31, i.e., by setting the maximum duty of the PWM control smaller. However, when the maximum duty of the PWM control is set smaller, this means the maximum amount of current supplied to the coil 3 is to be limited. For this reason, the maximum duty cannot be set below a duty that is required to supply the coil 3 with a current corresponding to the maximum current target value. Due to the sinusoidal nature of the waveform, there are drive steps having low current target values. In spite of this, Ttimer needs to be set to the timer unit 31 in accordance with the duty that is required to supply a current corresponding to the peak value of the sinusoidal wave for the above reason. Hence, an appropriate setting cannot be executed to the lower current values, meaning that the current ripple cannot be reduced with the utmost efficacy. In consideration of this problem, the object of the present embodiment is to provide an appropriate setting for the drive steps other than the drive step corresponding to the peak value of the sinusoidal wave. The following is a description of an operation performed by the stepping motor drive apparatus of the fourth embodiment.

First, an explanation is given as to an operation performed by the step control unit 56 and the reference signal generator 14b. The step control unit 56 outputs a signal showing a timing of changing a current target value, i.e., the step signal 60, to the reference signal generator 14b. In sync with the timing, the reference signal generator 14b outputs a sinusoidal waveform as the reference signal 66, which is obtained by smoothing out the staircase waveform shown in FIG. 16, to the comparator 16.

Next, an explanation is given as to a period of time measured by the timer unit 31 until the output of the completion signal. Receiving the step signal 60 from the step control unit 56, the memory unit 51a outputs the time limit of the PWM ON period (i.e., the timer setting value) corresponding to the drive step value indicated by the step signal 60, to the timer unit 31. Thus, optimization can be so performed that the maximum duty of the PWM control is set large when the step signal 60 indicates a large current target value and the maximum duty of the PWM control is set small when the step signal 60 indicates a small current target value. It should be noted here that a different time limit of the PWM ON period does not need to be held for each drive step value and it is possible to hold the same time limit for a plurality of drive steps.

The timer unit 31 measures the time limit of the PWM ON period (i.e., the timer setting value) inputted from the memory unit 51a, and outputs the completion signal when finishing the measurement. When the coil current state has not transitioned to the PWM OFF period at the time of the signal output, the timer unit 31 causes the transition to the PWM OFF period to take place.

In addition to the effect achieved in the first embodiment, the operation described in the fourth embodiment can optimize the effect of preventing the increase in the current ripple for the case where the drive step indicates a low current target value. Consequently, the stepping motor drive apparatus of the present embodiment can operate with lower noise and lower vibration.

### Fifth Embodiment

The following is a description of the fifth embodiment of the present invention.

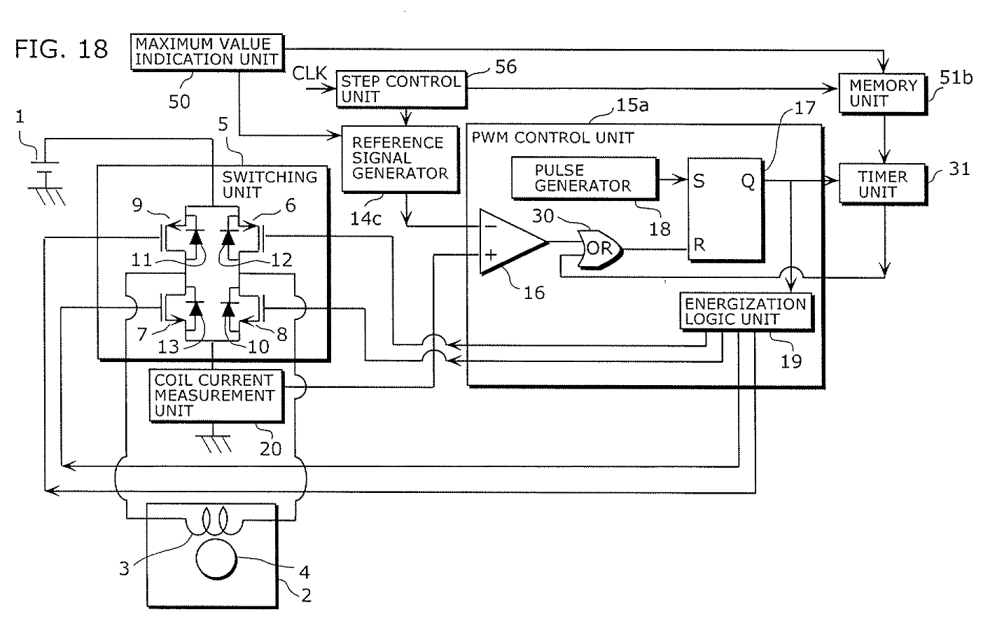

A stepping motor drive apparatus according to the fifth embodiment is different from the stepping motor drive apparatus according to the fourth embodiment in that a period of time measured by the timer unit 31 until the output of the completion signal is selected from a memory unit, corresponding to a drive step of a stepping motor and a maximum current target value. In the fifth embodiment, an explanation is mainly given as to differences from the first and fourth embodiments, with reference to FIGS. 18 to 20. Note that the same operations as in the first and fourth embodiments are not repeated here.

FIG. 18 is a block diagram showing a construction of the stepping motor drive apparatus according to the fifth embodiment of the present invention. The stepping motor drive apparatus is composed of: a power source 1; a stepping motor 2 that is a controlled object having a coil 3 and a rotator 4; a switching unit 5 for controlling a current to be supplied to the coil 3; a reference signal generator 14c for generating a reference signal showing a current limit value; a PWM control unit 15a; a coil current measurement unit 20; a timer unit 31; a step control unit 56; a maximum value indication unit 50; and a memory unit 51b. The switching unit 5 has transistors 6 to 9 and flywheel diodes 10 to 13, which form current supply paths to the coil 3. The present stepping motor drive apparatus is different from the apparatus of the fourth embodiment shown in FIG. 14 in that the reference signal generator 14b and the memory unit 51a are replaced respectively with the reference signal generator 14c and the memory unit 51b, and that the maximum value indication unit 50 is added.

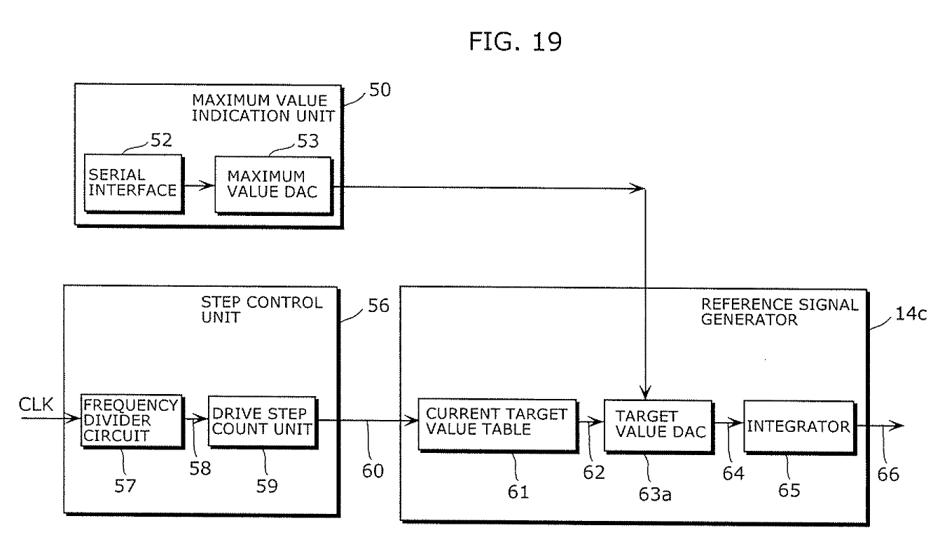

The reference signal generator 14c is a circuit that outputs a current target value, corresponding to a step signal 60 outputted from the step control unit 56 and a maximum current target value outputted from the maximum value indication unit 50. As shown in FIG. 19, the reference signal generator 14c has a current target value table 61, a maximum current value output DAC 63a, and an integrator 65.

The current target value table 61 is the same as the one described in the fourth embodiment. More specifically, the current target value table 61 outputs a specifying code 62 that specifies the current target value corresponding to the step signal 60 outputted from the step control unit 56, to the target value DAC 63a. One example of the specifying code 62 is a digital value representing a percentage of the current target value corresponding to the step signal 60 with respect to the peak current value. In this case, the target value DAC 63a outputs a product of the percentage shown by the specifying code 62 and the maximum current target value outputted from the maximum value indication unit 50. To be more specific, the target value DAC 63a performs digital-to-analog conversion and then outputs a signal having the input maximum current target value as the peak current value.

Additionally, another example of the specifying code 62 is a command for selecting the current target value corresponding to the step signal 60 from among a plurality of current target values to be generated in the subsequent stage of the circuit. In this case, the target value DAC 63a generates the plurality of current target values, which have the input maximum current target value as the peak current value, corresponding to the drive steps, selects the current target value specified by the specifying code 62 from among the plurality of the values, and outputs the selected current target value as the staircase waveform 64. This stair-like form of the staircase waveform 64 results from discrete inputs to the target value DAC 63a. Here, in order to avoid abrupt current variations due to the stepwise motion, the staircase waveform 64 is first outputted to the integrator 65, such as a low-pass filter, which smoothes out the staircase waveform 64. Then, a sinusoidal reference signal 66 obtained as a result is outputted as the current target value. In the case where the abrupt current variations due to the stepwise motion are allowable, the integrator 65 is not needed and the staircase waveform 64 may be used as the reference signal 66.

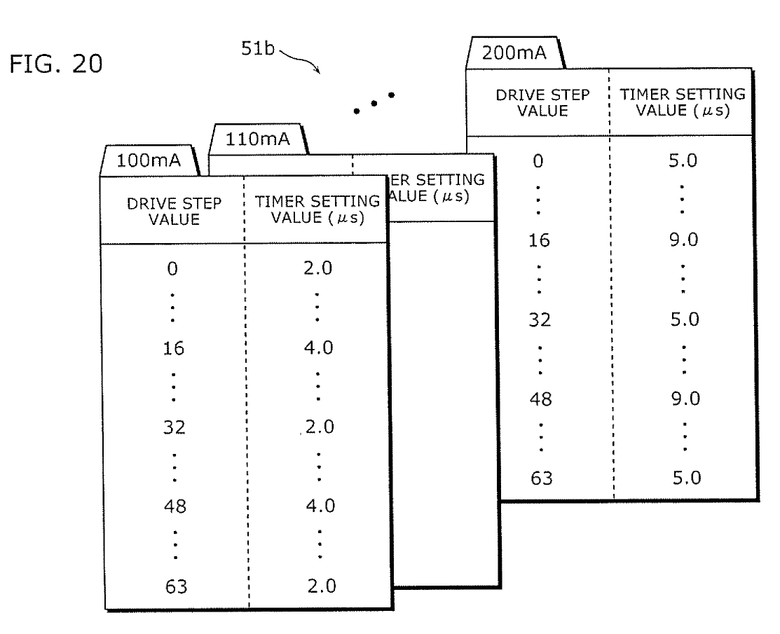

The memory unit 51b is a memory or the like which stores a table, for each of the plurality of the maximum target values, that shows a correspondence between the drive step value shown by the step signal 60 indicated by the step control unit 56 and the timer setting value, as shown in FIG. 20. Here, the drive step values are integers 0 to 63, and each timer setting value represents a period of time that is shorter than the PWM cycle. The memory unit 51b holds the table to show a duty that is required to supply a current corresponding to the current target value for each combination of the maximum current target value indicated by the maximum value indication unit 50 and the drive step value indicated by the step signal 60. The duty referred to here is a time limit of the PWM ON period, that is, a timer setting value.

The maximum value indication unit 50 is the same one as described in the second embodiment. More specifically, the maximum value indication unit 50 indicates the maximum current target value to the reference signal generator 14c and the memory unit 51b.

The features of the stepping motor drive apparatus of the fifth embodiment having this construction are as follows. The stepping motor drive apparatus of the fourth embodiment can optimize the effect of preventing the increase in the current ripple even for the drive steps with lower current target values. However, in the case where the maximum current target value varies among a plurality of different values, i.e., where the peak value of the sinusoidal current target values varies among a plurality of values, a time limit of the PWM ON period needs to be set for each drive step on the premise of the sinusoidal current target values having the maximum peak current value. For this reason, an appropriate setting cannot be executed to sinusoidal current target values having a lower peak current value, meaning that the current ripple cannot be reduced with the utmost efficacy. In consideration of this problem, the object of the present embodiment is to provide an appropriate setting for the plurality of current target values having different peak current values.

The following is a description of an operation performed by the stepping motor drive apparatus of the fifth embodiment.

First, an explanation is given as to the current target value generated by the maximum value indication unit 50, the step control unit 56, and the reference signal generator 14c. As explained above in the second embodiment, the maximum value DAC 53 outputs the maximum current target value indicated by the serial interface 52 to the reference signal generator 14c. Moreover, as explained above in the fourth embodiment, the step control unit 56 outputs the step signal 60 as the signal showing the drive step value to the reference signal generator 14c.

The current target value table 61 of the reference signal generator 14c outputs a specifying code 62 that specifies the current target value corresponding to the step signal 60 outputted from the step control unit 56, to the target value DAC 63a. The target value DAC 63a then outputs a product of the percentage representing the current target value shown by the specifying code 62 and the maximum current target value outputted from the maximum value indication unit 50. Here, this product is outputted as a staircase waveform 64. To be more specific, the target value DAC 63a generates a plurality of current target values, which have the input maximum current target value as the peak current value, corresponding to the step signal 60, selects the current target value specified by the specifying code 62, then outputs the value as the staircase waveform 64. The staircase waveform 64 outputted from the current target value output 63a is first outputted to the integrator 65, such as a low-pass filter, which smoothes out the staircase waveform 64. Then, a sinusoidal reference signal 66 obtained as a result is outputted as the current target value.

Next, an explanation is given as to a period of time measured by the timer unit 31 until the output of the completion signal. Receiving the step signal 60 from the step control unit 56 and the maximum current target value or the code specifying the maximum current target value from the maximum value indication unit 50, the memory unit 51b outputs the corresponding time limit of the PWM ON period (i.e., the timer setting value) for each combination of the drive step value and the maximum current target value, to the timer unit 31.

Accordingly, the stepping motor drive apparatus of the present invention can perform optimization so that the maximum duty of the PWM control is set large when the maximum current target value is large and that the maximum duty of the PWM control is set small when the maximum current target value is small. Moreover, the apparatus can further perform optimization so that the maximum duty of the PWM control is set large for the drive step having the large current target value and that the maximum duty of the PWM control is set small for the drive step value having the small current target value.

It should be noted here that a different time limit of the PWM ON period does not need to be held for each drive step value belonging to the same one sinusoidal waveform, and it is possible to hold the same time limit for a plurality of drive steps.

In the present embodiment, the memory unit 51b is constructed as the table that shows a correspondence between the time limit of the PWM ON period and a combination of the maximum current target value indicated by the maximum value indication unit 50 and the drive step value shown by the step signal 60. However, the same effect as in the present embodiment can also be achieved in the case where the memory unit 51b holds an equation where the maximum current target value is an input and then outputs a time limit of the PWM ON period as a result of the calculation. As one example of the equation, when the power source voltage is represented as “V”, a path resistance during the PWM ON period as “R”, the input maximum current target value as “Imax”, the output time limit of the PWM ON period as “Ton”, the PWM cycle as “T”, a margin factor corresponding to variations as “α”, and the percentage representing the current target value corresponding to a drive step “n” with respect to the peak value as βn, the equation is expressed as: [Ton=βn·α·Imax·T·R/V]. Obviously, the equation is not limited to this. The same effect of the present invention can be achieved using a different equation as long as the time limit of the PWM ON period that allows the maximum current corresponding to the input maximum current target value to be supplied to the coil 3 is outputted according to the equation.

The timer unit 31 measures the time limit of the PWM ON period (i.e., the timer setting value) inputted from the memory unit 51b, and outputs the completion signal when finishing the measurement. When the coil current state has not transitioned to the PWM OFF period at the time of the signal output, the timer unit 31 causes the transition to the PWM OFF period to take place.

In addition to the effect achieved in the fourth embodiment, the operation described in the fifth embodiment can optimize the effect of preventing the increase in the current ripple for the plurality of the current target values having different peak values. Accordingly, the stepping motor drive apparatus of the present embodiment can operate with lower noise and lower vibration.

### Sixth Embodiment

The following is a description of the sixth embodiment of the present invention.

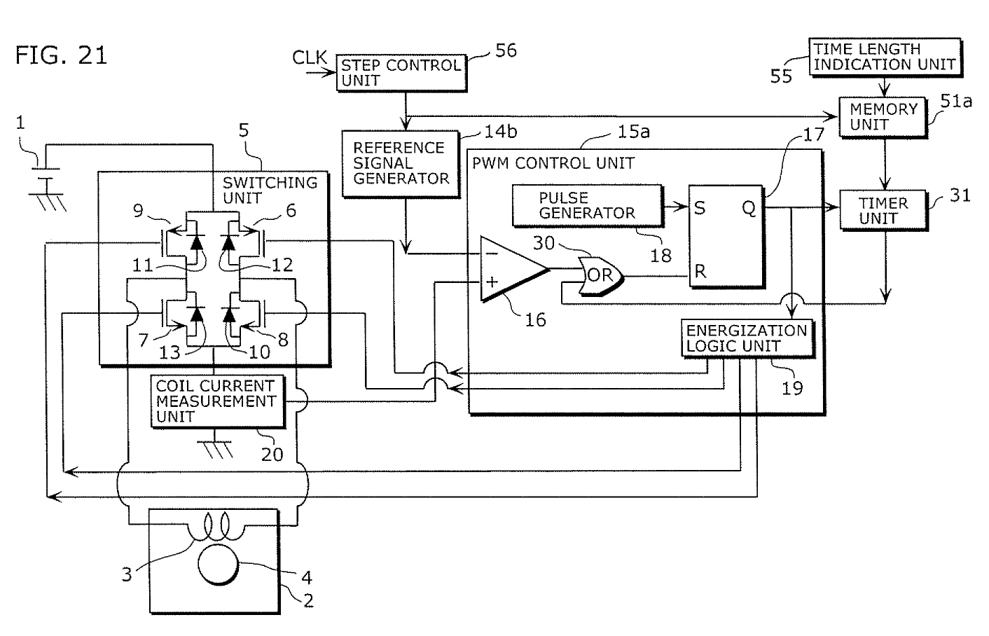

A stepping motor drive apparatus according to the sixth embodiment is different from the stepping motor drive apparatus according to the fourth embodiment in that a period of time measured by the timer unit 31 until the output of the completion signal is specified arbitrarily and precisely according to control by a microcomputer or a command from the user for each drive step in accordance with the maximum current target value. In the sixth embodiment, an explanation is mainly given as to differences from the first and fourth embodiments, with reference to FIG. 21. Note that the same operations as in the first and fourth embodiments are not repeated here.

FIG. 21 is a block diagram showing a construction of the stepping motor drive apparatus according to the sixth embodiment of the present invention. The stepping motor drive apparatus is composed of: a power source 1; a stepping motor 2 that is a controlled object having a coil 3 and a rotator 4; a switching unit 5 for controlling a current to be supplied to the coil 3; a reference signal generator 14b for generating a reference signal showing a current limit value; a PWM control unit 15a; a coil current measurement unit 20; a timer unit 31; a step control unit 56; a memory unit 51a; and a time length indication unit 55. The switching unit 5 has transistors 6 to 9 and flywheel diodes 10 to 13, which form current supply paths to the coil 3. The present stepping motor drive apparatus is different from the apparatus of the fourth embodiment shown in FIG. 14 in that the time length indication unit 55 is added.

The time length indication unit 55 is a serial interface or the like that outputs (or, indicates) to the memory unit 51a a plurality of combinations of a time position shown by a step signal outputted from the step control unit 56 and a timer setting value showing a period of time to set to the timer unit 31, according to control of a microcomputer or a command from a user. When the maximum current target value changes, the time length indication unit 55 indicates to the memory unit 51a a new set of timer setting values (64 timer setting values, for example) for the maximum current target value, so that the memory unit 51 is updated.

The memory unit 51a is the same one as described in the fourth embodiment. More specifically, the memory unit 51a is a RAM or the like which holds a table showing a correspondence between the time position and the timer setting value indicated by the time length indication unit 55. When receiving a step signal from the step control unit 56, the memory unit 51a reads the timer setting value corresponding to the time position shown by the step signal from the table and outputs the read value to the timer unit 31. Moreover, the memory unit 51a updates the table by the new set of the timer setting values (64 timer setting values, for example) received from the time length indication unit 55.

The features of the stepping motor drive apparatus of the sixth embodiment having this construction are as follows. In the case of the stepping motor drive apparatus according to the fourth embodiment, when the maximum current target value varies among a plurality of different values, i.e., when the peak value of the sinusoidal current target values varies among a plurality of values, a time limit of the PWM ON period needs to be set for each drive step on the premise of the sinusoidal current target values having the maximum peak current value. For this reason, the apparatus of the fourth embodiment cannot perform an appropriate setting on sinusoidal current target values having a lower peak current value, meaning that the current ripple cannot be reduced with the utmost efficacy. In consideration of this problem, the object of the present embodiment is to provide an appropriate setting for the plurality of current target values having different peak current values. The following is a description of an operation performed by the stepping motor drive apparatus of the sixth embodiment.

An explanation is given as to a period of time measured by the timer unit 31 until the output of the completion signal. The memory unit 51a previously stores the table showing a correspondence between the time position and the timer setting value indicated by the time length indication unit 55, that is, a set of timer setting values corresponding to the (maximum) current target value. Receiving the step signal 60 from the step control unit 56, the memory unit 51a outputs the time limit of the PWM ON period (i.e., the timer setting value) corresponding to the drive step value shown by the step signal 60, to the timer unit 31.

Accordingly, the stepping motor drive apparatus of the present invention can perform optimization so that the maximum duty of the PWM control is set large when the maximum current target value is large and that the maximum duty of the PWM control is set small when the maximum current target value is small. Moreover, the apparatus can further perform optimization so that the maximum duty of the PWM control is set large for the drive step having the large current target value and that the maximum duty of the PWM control is set small for the drive step value having the small current target value.

The timer unit 31 measures the time limit of the PWM ON period inputted from the memory unit 51a, and outputs the completion signal when finishing the measurement. When the coil current state has not transitioned to the PWM OFF period at the time of the signal output, the timer unit 31 causes the transition to the PWM OFF period to take place.

In addition to the effect achieved in the fourth embodiment, the operation described in the sixth embodiment can optimize the effect of preventing the increase in the current ripple for the plurality of the current target values having different peak values. Consequently, the stepping motor drive apparatus of the present embodiment can operate with lower noise and lower vibration.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is useful as an apparatus for driving a stepping motor by pulse-width modulation control, and especially as a stepping motor drive apparatus, a control apparatus, and a control program for preventing an increase in current ripple and a decrease in current frequency to reduce noise and vibration.

What is claimed is:

1. A stepping motor drive apparatus for driving a stepping motor, comprising:
a reference signal generation unit operable to generate a reference signal that shows a current limit value of a current to be supplied to a coil included in said stepping motor;
a switching unit operable to supply the current to the coil in an ON state, and to stop the current supply to the coil in an OFF state;
a coil current measurement unit operable to measure the current supplied to the coil;
a standard pulse generation unit operable to output a standard pulse at a fixed time interval;
a timer unit operable to output a completion signal which indicates that a predetermined period of time shorter than the fixed time interval has elapsed since the standard pulse was outputted; and
a control unit operable to set said switching unit to the ON state at a point in time when the standard pulse is outputted, and to set said switching unit to the OFF state either at a point in time when the current measured by said coil current measurement unit exceeds the current limit value shown by the reference signal or at a point in time when the completion signal is outputted from said timer unit, whichever occurs first.

2. The stepping motor drive apparatus according to claim 1,
wherein said control unit has:
a comparator operable to detect that the current has exceeded the current limit value by comparing a signal which shows an amount of the current measured by said coil current measurement unit with the reference signal;
an OR gate operable to perform an OR operation on an output signal from said comparator and the completion signal from said timer unit;
a flip-flop which is set by the standard pulse and reset by an output signal from said OR gate; and
an energization logic unit operable to set said switching unit to the ON state when an output signal from said flip-flop is in a first state, and to set said switching unit to the OFF state when the output signal from said flip-flop is in a second state,

3. The stepping motor drive apparatus according to claim 1, further comprising:
a maximum value indication unit operable to indicate a maximum value of the current limit value; and
a memory unit operable to hold a table which stores a plurality of combinations each including the maximum value and a timer setting value representing a period of time for which said timer unit is set, to read the timer setting value from the table corresponding to the maximum value indicated by said maximum value indication unit, and then to output the read timer setting value to said timer unit,
wherein said timer unit is operable to measure the predetermined period of time by reference to the timer setting value outputted from said memory unit, and to output the completion signal on completion of measuring the predetermined period of time, and
said reference signal generation unit is operable to generate the reference signal that causes a maximum value of the current limit value shown by the reference signal to be the maximum value indicated by said maximum value indication unit.

4. The stepping motor drive apparatus according to claim 1, further comprising
a time length indication unit operable to indicate to said timer unit a timer setting value representing a period of time, for which said timer unit is set,
wherein said timer unit is operable to measure the predetermined period of time by reference to the timer setting value indicated by said time length indication unit, and to output the completion signal on completion of measuring the predetermined period of time.

5. The stepping motor drive apparatus according to claim 1, further comprising:
a step control unit operable to output a step signal at a fixed time interval, the step signal showing a time position in one cycle of the reference signal; and
a memory unit operable
to hold a table which stores a plurality of combinations each including the time position shown by the step signal and a timer setting value representing a period of time for which said timer unit is set,
to read, when receiving the step signal from said step control unit, the timer setting value from the table corresponding to the time position shown by the received step signal, and then
to output the read timer setting value to said timer unit,
wherein said timer unit is operable to measure the predetermined period of time by reference to the timer setting value outputted from said memory unit, and to output the completion signal on completion of measuring the predetermined period of time, and
said reference signal generation unit is operable, when receiving the step signal from said step control unit, to generate the reference signal that shows the current limit value corresponding to the time position shown by the received step signal.

6. The stepping motor drive apparatus according to claim 1, further comprising:
a maximum value indication unit operable to indicate a maximum value of the current limit value;
a step control unit operable to output a step signal at a fixed time interval, the step signal showing a time position in one cycle of the reference signal; and
a memory unit operable
to hold a table which stores a plurality of combinations each including a timer setting value representing a period of time for which said timer unit is set and a pair of the maximum value and the time position shown by the step signal,
to read, when receiving the step signal from said step control unit, the timer setting value from the table corresponding to the combination of the maximum value indicated by said maximum value indication unit and the time position shown by the step signal outputted from said step control unit, and then
to output the read timer setting value to said timer unit,
wherein said timer unit is operable to measure the predetermined period of time by reference to the timer setting value outputted from said memory unit, and to output the completion signal on completion of measuring the predetermined period of time, and
said reference signal generation unit is operable, when receiving the step signal from said step control unit, to generate the reference signal that shows the current limit value corresponding to the combination of the maximum value indicated by said maximum value indication unit and the time position shown by the step signal outputted from said step control unit.

7. The stepping motor drive apparatus according to claim 1, further comprising:
a step control unit operable to output a step signal at a fixed time interval, the step signal showing a time position in one cycle of the reference signal;
a time length indication unit operable to indicate a plurality of combinations each including the time position shown by the step signal and a timer setting value representing a period of time for which said timer unit is set; and
a memory unit operable
to hold a table which stores the plurality of combinations indicated by said time length indication unit,
to read, when receiving the step signal from said step control unit, the timer setting value from the table corresponding to the time position shown by the received step signal, and then
to output the read timer setting value to said timer unit,
wherein said timer unit is operable to measure the predetermined period of time by reference to the timer setting value outputted from said memory unit, and to output the completion signal on completion of measuring the predetermined period of time, and
said reference signal generation unit is operable, when receiving the step signal from said step control unit, to generate the reference signal that shows the current limit value corresponding to the time position shown by the received step signal.

8. The stepping motor drive apparatus according to claim 1, further comprising
a timer setting value calculation unit operable
to receive an indication regarding at least one of a maximum value of the current limit value and a time position in one cycle of the current limit value and
to calculate a timer setting value representing a period of time for which said timer unit is set, from at least one of the indicated maximum value and the indicated time position,
wherein said timer unit is operable to measure the predetermined period of time by reference to the timer setting value calculated by said timer setting value calculation unit, and to output the completion signal on completion of measuring the predetermined period of time.

9. A control method for a stepping motor drive apparatus including a reference signal generation unit operable to generate a reference signal that shows a current limit value of a current to be supplied to a coil included in said stepping motor, a switching unit operable to supply the current to the coil in an ON state, and to stop the current supply to the coil in an OFF state, a coil current measurement unit operable to measure the current supplied to the coil, a standard pulse generation unit operable to output a standard pulse at a fixed time interval, and a timer unit operable to output a completion signal which indicates that a predetermined period of time shorter than the fixed time interval has elapsed since the standard pulse was outputted,
said control method comprising
setting said switching unit to the ON state at a point in time when the standard pulse is outputted, and setting said switching unit to the OFF state either at a point in time when the current measured by said coil current measurement unit exceeds the current limit value shown by the reference signal or at a point in time when the completion signal is outputted from said timer unit, whichever occurs first.
